(19) United States
(12) Patent Application Publication
(10) Pub. No.: US 2021/0270343 A1
(43) Pub. Date: Sep. 2, 2021

(54) ROTARY DAMPER

(71) Applicant: INVENTUS ENGINEERING GMBH, ST. ANTON I.M. (AT)

(72) Inventor: STEFAN BATTLOGG, ST. ANTON I.M. (AT)

(21) Appl. No.: 17/255,164

(22) PCT Filed: Jul. 4, 2019
(86) PCT No.: PCT/EP2019/068033

§ 371 Date: Jan. 19, 2021

(30) Foreign Application Priority Data
Jul. 4, 2018 (DE) 10 2018 116 187.5

(51) Int. Cl. F16F 9/53; F16F 9/14; B60G 17/08; B60G 21/055

(52) U.S. Cl. CPC F16F 9/535; F16F 9/145; B60G 2202/22; B60G 21/055; B60G 17/08

(57) ABSTRACT

A rotary damper has a housing, a damper shaft rotatably held on the housing, a damper volume accommodated in the housing and which has a magnetorheological fluid as working fluid, and at least one magnetic field source in order to influence a degree of damping of the rotational movement of the damper shaft relative to the housing. A separating unit connected to the damper shaft divides the damper volume. At least one gap portion, which can be influenced by a magnetic field of the magnetic field source, is formed between the separating unit, which is connected to the damper shaft, and the housing. The housing, the separating unit and the magnetic field source are designed such that a flow cross section for the magnetorheological fluid from one side to the other side of the separating unit changes in dependence on a rotational angle.

The present invention relates to a rotary damper, wherein the rotary damper comprises a housing and a damper shaft accommodated rotatably on said housing. In the housing, there is provided a damper volume which has a magnetorheological fluid as working fluid, in order to influence a damping of the rotational or pivoting movement of the damper shaft relative to the housing.

In the prior art, a wide variety of rotary dampers or rotation dampers have become known by means of which a damping of a pivoting movement or of a rotational movement of a damper shaft is possible. In particular if the required or available angle of rotation or pivot angle is limited, the known rotary dampers are often not applicable with sufficient flexibility, or the required braking moment is too low or the required rotational speeds are too high, such that the braking moment cannot be changed or set at all, or cannot be changed or set sufficiently quickly.

Rotation dampers with oil and external control valves are prior art. In particular in the case of prosthetics but also in the case of other applications, a small space requirement is a major advantage. This means that the effective surfaces are small and therefore the working pressure must be increased (100 bar and more) in order that corresponding surface pressures and thus forces or moments can be generated. A disadvantage in the case of these actuators is that the parts which move relative to one another must be produced with very high accuracy in order that the greatest possible pressure loss occurs in the gaps and therefore a sealing action is attained. These narrow gap dimensions and closely toleranced slide pairings increase the hydraulic and mechanical base friction/moments, which has an adverse effect on the functionality and the response behavior. As a further consequence, high levels of mechanical wear and short servicing intervals must be expected. Since it is often the case here that internal contours and rectangular or bulky components/sealing edges are involved, and these must preferably be ground in order that the tolerances/gaps are correspondingly good, the costs for these are very high. The alternative fitting of sealing elements is likewise cumbersome and expensive in the case of these contours and pressures. It is particularly difficult to seal the edges or the transitions from, for example, the axial to the radial contour. Furthermore, seals give rise to a high level of base friction or base friction forces and moments.

U.S. Pat. No. 6,318,522 B1 has disclosed a stabilizer with a rotation damper with magnetic seals for a motor vehicle. Here, on the stabilizer, there are included two rotation dampers, each of which rotation dampers having in each case one shaft with two outwardly extending vanes. The shaft can pivot with the vanes, wherein the pivot angle is limited by wedge-shaped guide plates in the housing, which project radially inward. Cavities or chambers are formed in the housing between the outwardly projecting vanes and the guide plates, of which cavities or chambers in each case two are increased in size during the pivoting of the shaft, whereas the other two are correspondingly reduced in size. A magnetorheological fluid is contained in the chambers. At the radially inner ends of the guide plates and at the radially outer and the axially outer ends of the vanes, there are arranged magnets which, by way of their magnetic field, seal off the radially inner, radially outer and axial gaps in order to limit the leakage flow. In this way, wear on the seals, which otherwise make contact, between the chambers is prevented, whereby the service life is increased. For the actual damping of the stabilizer, bores are provided in the guide plates, which bores interconnect chambers which correspond to one another. In the bores, there are contained spring-loaded ball valves which open the flow path when the pressure difference in the two chambers exceeds the preset spring force. Thus, U.S. Pat. No. 6,318,522 B1 provides a low-maintenance stabilizer which functions reliably. A disadvantage is however that a considerable level of base friction is present, because the seal of the gaps is configured for the provided damping force. A further disadvantage is that the damping force cannot be varied.

DE 10 2013 203 331 A1 has disclosed the use of a magnetorheological fluid for the damping of relative movements between vehicle wheels and vehicle body in a vehicle. Here, a transmission stage with multiple toothed gears which are operatively connected is provided. The transmission stage is filled with the magnetorheological fluid. The outflow from the transmission stage is conducted to an external valve, where a magnetic field acts on the magnetorheological fluid before the fluid is conducted back to flow to the housing. A disadvantage of this is that the housing with the transmission stage is filled with the magnetorheological fluid. Magnetorheological fluids refer to a suspension of magnetically polarizable particles (carbonyl iron powder) which are finely dispersed in a carrier liquid and have a diameter between approximately 1 micrometer and 10 μm. Therefore, all gaps between components which move relative to one another (axial gaps between the rotating toothed gear and the housing, radial gaps between the tooth flank and housing internal bore and also gaps between the tooth profiles which make contact/mesh in the transmission stage) must be larger than the largest magnetic particles. In practice, the gaps must even be several times larger, because the particles, even in the absence of a magnetic field, can clump together to form larger agglomerations, or interlink under the action of a magnetic field and thus form larger carbonyl iron units. An incorrectly selected gap leads to jamming/seizing, or the (coated) particles are broken down and thus become unusable. This however has the significant disadvantage that, owing to these imperatively required gaps, large leakage flows occur, in particular if pressures of over 100 bar are to be attained therewith. A high level of damping therefore cannot be attained. To attain high damping values, all gaps must be sealed off with great effort, which is expensive or in some cases technically not possible at all. For example, it is not practically possible to seal off a rolling gap between two involute tooth profiles. High-pressure-tight face-side sealing of a toothed wheel of complex shape in combination with iron-containing liquids is not practicable in an economically sensible manner in a mass production context. If, however, the gaps were to be sealed off by means of magnets, as known from U.S. Pat. No. 6,318,522 B1, a damping of relatively low forces would not function satisfactorily owing to the high base friction. Owing to the high base moment, only high torques can be dampened with acceptable response behavior. Therefore, the design principle from DE 10 2013 203 331 A1 in combination with magnetorheological liquids is not suitable for the production of inexpensive and flexibly settable rotation dampers for damping low and also high forces or moments.

It is therefore the object of the present invention to provide an in particular inexpensive rotary damper which makes possible a low base moment and a flexible setting of the damping of the damper shaft and allows the satisfactory damping of high and low forces and torques and which is of simple construction.

Said object is achieved by means of a rotary damper having the features of claim 1. The subclaims relate to preferred developments of the invention. Further advantages and features of the present invention will emerge from the general description and from the description of the exemplary embodiments.

A rotary damper according to the invention comprises a housing and a damper shaft accommodated rotatably on said housing so as to be rotatable relative thereto. In the housing, there is accommodated a damper volume with a magnetorheological fluid as working fluid. At least one magnetic field source is provided in order to influence a damping of the rotational movement of the damper shaft relative to the housing. At least one separating unit which is connected to the damper shaft comprises a separating wall and may preferably be formed as a pivot vane. The separating unit connected to the damper shaft divides the damper volume. Between the separating unit, which is connected to the housing, and the damper shaft, there is formed at least one gap section or part of a gap, which can preferably be influenced by means of a magnetic field of the magnetic field source.

The housing and/or the separating unit and/or the magnetic field source, and preferably the housing and the separating unit and the magnetic field source, are formed such that a flow cross section for the magnetorheological fluid from one side of the separating unit to the other side of the separating unit changes in a manner dependent on an angle of rotation.

The invention has numerous advantages. A major advantage is that, for example in a basic position or in various angle positions, a base moment can be selected to be relatively low or relatively high. In this way, targeted influencing of the rotational resistance can be set. The influencing can be realized by means of mechanical components and/or through control of the magnetic field, and in particular strengthened or weakened through control of the magnetic field.

The magnetic field source comprises at least one controllable electrical coil and may comprise at least one permanent magnet. At least one electrical coil and at least one permanent magnet have the advantage that the magnetic field of the permanent magnet can be modulated (strengthened and/or weakened) by means of the electrical coil.

A considerable change in the effective flow cross section is not caused (only or exclusively) by manufacturing tolerances or faults owing to the movement (radial runout).

Preferably, a channel or bypass is formed in the housing on the wall which surrounds the damper volume, which channel or bypass extends over a limited angle range and/or acts over a limited angle range. The channel or bypass may be formed in the manner of a groove on the inner surface of a circumferential wall or else (partially) entirely within the circumferential wall. It is also possible for a channel or bypass to be formed on an axial wall of the housing. The channel or bypass may be formed on the surface or run at least partially within the wall.

An effective angle range can be limited by the length of the channel or bypass or by mechanical means such as a projection, a lug or an edge. The length and depth of a groove can also limit an effective angle range.

Preferably, a cross section of the channel or bypass is angle-dependent. For example, the channel or bypass may be formed in a non-circular housing section or a housing section with varying radius. It is also possible for the channel or bypass to be formed on a housing section with a radius that differs from a radius of the separating unit and with mutually offset central points. The result is then a channel depth which varies over the circumference.

At least one recess is preferably formed in the separating unit. The recess may be formed at an edge of the separating unit or may be open toward the edge of the separating unit. Preferably, the recess has a gap height in relation to the housing surrounding the damper volume, which gap height is considerably greater than a gap height in the gap section adjoined by the recess. A ratio of the gap heights of recess and gap section is preferably greater than 2 and in particular greater than 4 or 6 and may assume or exceed values greater than 10 or 20.

In particular, an (effective or) active cross section of the recess may change in angle-dependent fashion by means of a projection on the housing. An interaction of a projection or of a lug or of an edge on the housing with a recess on the separating unit can give rise to an angle-dependent cross-sectional area.

Preferably, an (effective) flow cross section is the flow cross section that is made up of the non-sealed cross sections of the present gap sections and of a cross section of a channel or bypass and of a cross section of a recess and of a cross section of a passage gap.

In particular, an effective flow cross section is made up of the active cross sections of the present gap sections and of an effective cross section of a channel or bypass and of an effective cross section of a recess and of an effective cross section of a passage gap.

Preferably, the or at least one recess adjoins a gap section.

In particular, an (effective) flow cross section is larger in a basic position than in a rotational position that differs considerably from said basic position. This allows, for example in the case of a stabilizer, an effective damping of unilateral shocks in the basic position and an effective action of the stabilizer in angle positions that differ therefrom.

In particular, the or at least one recess is formed as a passage gap in a separating wall of the separating unit.

Preferably, a cross section of the passage gap extends further in an axial direction than in a radial direction of the separating unit. A ratio of an axial extent parallel to the damper shaft relative to a radial extent is preferably greater than 2 and in particular greater than 5 and particularly preferably greater than 10, and may assume and exceed values of 20, 30, 40, 50 and 100.

A radial gap height is preferably greater than 50 μm and in particular greater than 75 μm. Preferably, a gap height is less than 1 mm and in particular less than 500 μm. A range is particularly preferably between 100 μm and 300 μm.

The axial gap length is made up of the length of the separating unit minus any required support elements and the edge sections.

It is possible and preferable for two or more passage gaps to be formed on the separating wall, which passage gaps are in particular separated from one another by a (thin) magnetically conductive web and preferably run parallel to one another. At least two passage gaps are arranged preferably radially offset with respect to one another.

In one specific refinement, three radially adjacent passage gaps each with a gap height of 200 μm (+/−10%) are used.

It is particularly preferable for at least one passage gap to be formed on a (separate) insert which is accommodated on the separating unit. For example, the insert may be adhesively bonded in, pressed in or screwed in.

The separating wall is preferably composed substantially of magnetically conductive material.

In particular, the separating wall of the separating unit, axially adjacent to a passage gap, is composed of a material which exhibits poorer magnetic conductivity than a radially adjacent section of the separating wall. It is thereby ensured that a considerable proportion of the magnetic field passes through the passage gap.

Preferably, the separating wall, in an edge section close to or at an axial edge, is composed of a magnetically conductive material. A permanent magnet may also be included there. A permanent magnet can, with its magnetic field, ensure sealing of an axial and/or radial gap section.

In all refinements, it is preferable for a channel, channel section or bypass to be equipped with a one-way valve. For example, a spring-preloaded plate may close a channel in one flow direction open up the cross section in the other flow direction.

In all refinements, it is preferable for a displacement device to be formed in the housing. The displacement device preferably comprises at least two separating units, by means of which the damper volume is divided into at least two variable chambers, wherein, in particular, at least one of the separating units comprises a separating wall connected to the housing. One separating unit has a separating wall connected to the damper shaft.

Preferably, a (first) (radial) gap section or gap is formed in a radial direction between the separating unit, which is connected to the housing, and the damper shaft. The first gap section runs substantially in an axial direction. A further (or a second) (radial) gap section is formed in a radial direction between the separating unit, which is connected to the damper shaft, and the housing. The further or second gap section runs, at least over a considerable extent, in an axial direction. At least one yet further (or a third) (axial) gap section is formed in an axial direction between the separating unit, which is connected to the damper shaft, and the housing. This (or the third gap section) runs, at least over a considerable extent, in a radial direction. At least a major part of the magnetic field of the magnetic field source passes through at least two of the stated gap sections. The magnetic field source comprises at least one controllable electrical coil in order to influence a strength of the magnetic field. Thus, an intensity of the damping and preferably also an intensity of the seal is influenced. In particular, a major part of the magnetic field of the magnetic field source passes through at least the two gap sections and, in a manner dependent on the strength of the magnetic field, influences at least the two gap sections simultaneously.

Each gap section may be formed as a separate gap, or two or more gap sections may be part of one common gap.

Each gap section has an extent direction or profile direction and a gap height transversely with respect to the profile direction. A purely axial gap section runs in a radial direction and/or in a circumferential direction. The gap height extends in an axial direction. A purely radial gap section extends in an axial direction and possibly also in a circumferential direction.

Here, the first and the second gap section particularly preferably run substantially in an axial direction, whereas the gap height extends in each case substantially in a radial direction. The third gap section is particularly preferably formed as an axial gap section, such that the gap height extends substantially in an axial direction. By contrast, the gap section extends substantially in a radial direction and/or in a circumferential direction.

The gaps or gap sections may each be of linear form. Each gap section may however also have one or more curves, or may be composed only of in each case curved gap regions.

It is advantageous if two or more gap sections and preferably all gap sections are sealed as required by means of the magnetic field of the magnetic field source. In this way, the gaps or gap sections can be formed with a sufficient gap height in order to provide a low level of base friction. It is however furthermore the case that, when the magnetic field is active, an intense seal is attained, such that high damping values are made possible. It is not necessary for a gap height to be selected to be particularly small in order for no leakage to occur. Leakage is prevented not by means of the gap dimension (gap height) but by means of a magnetic seal. By means of a settable strength of the magnetic field, the intensity of the damping can be adaptively adjusted.

With the controllable electrical coil, a magnetic field of desired intensity can be set in a flexible manner. In this way, a damping of desired intensity is set. It is in particular also the case that an intensity of the seal of at least two gaps and in particular of all radial and axial gaps is set at the same time as a result. The base friction is low if the magnetic field is weak, and the sealing action is intense if the relative pressure or the torque is high. Thus, very much greater dynamics can be provided than in the case of the prior art, because not only the damping itself but also the sealing is influenced.

In fact, a braking moment acts which is made up by addition of the present base moment and of the damping moment. Here, base moment and damping moment are each influenced by the (time-dependent and temporally controllable) active magnetic field. In the case of low forces and moments to be dampened, a relatively low base friction (base moment) is generated with a relatively low strength of the magnetic field. In the case of relatively high forces and moments to be dampened, a relatively high base friction (base moment) is generated with a relatively high strength of the magnetic field. A relatively high base moment, in the case of a correspondingly relatively high braking moment, does not have an adverse effect on the response behavior. In particular, a ratio of braking moment to a base moment in a middle operating range (in particular exactly in the middle) is greater than 2:1 and preferably greater than 5:1 and particularly preferably greater than 10:1.

In the case of conventional seals in pure oil circuits, it is, by contrast, necessary to select a particularly small gap dimension if an intense seal is to be attained. This simultaneously also results in a high base moment in operation without load, and correspondingly intense wear on the seals. This is avoided according to the invention.

In a particularly preferred refinement, the gap sections are each formed as a gap. The gaps may, in part, transition into one another or be formed separately from one another. It is then possible in this application for the expression “gap section” to be replaced throughout with the expression “gap”.

In a preferred refinement, a major part of the magnetic field of the magnetic field source passes through at least one and in particular two axial gap sections, formed at opposite ends, between the housing and at least one of the separating units in order to seal off the lateral axial gaps. The magnetic field that passes through there causes the magnetorheological particles present in the axial gap to interlink with one another, such that a complete seal, which is effective even at high pressures, is realized. Alternatively or in addition, it is also possible for at least one radial gap section or gap between the separating unit, which is connected to the damper shaft, and the housing to be subjected to the magnetic field, such that, when the magnetic field is active, said radial gap (gap section) is also sealed.

In a preferred development, at least one of the gap sections is formed as a damping gap and at least one of the gap sections is formed as a sealing gap. Here, at least one damping gap has preferably a (considerably) greater gap height than a sealing gap. In particular, a gap height of the damping gap is at least twice as large or at least 4 times as large or at least 8 times as large as a gap height of a sealing gap. It is preferable for a gap height of a sealing gap to be greater than 10 μm and in particular greater than 20 μm and preferably between approximately 20 μm and 50 μm. By contrast, a gap height of a damping gap is preferably >100 μm and preferably >250 μm and is preferably between 200 μm and 2 mm gap height. In advantageous refinements, the gap height of a damping gap may be between (approximately) 500 μm and 1 mm.

It is basically the case that all gap sections contribute to, or influence, the damping. A flow through a damping gap (with a relatively large gap height) can be controlled in an effective manner by means of a control device, such that the acting braking moment can be exactly set. A correspondingly large volume flow can be transported through a damping gap with a relatively large gap height.

The magnetic field source preferably comprises at least one electrical coil. It is also possible for 2, 3 or more electrical coils to be used in order to form the magnetic field of the magnetic field source. It is also possible for the magnetic field source to comprise at least one permanent magnet, or for at least one permanent magnet to be assigned to the magnetic field source.

Targeted angle-dependent influencing of the base moment can be provided by means of a bypass or a recess or through control of the magnetic field. In a simple case, the base moment is considerably reduced in a particular angle range by means of a bypass. There, the (effective) flow cross section in the case of a deactivated magnetic field is considerably enlarged, and for example at least doubled.

Such an angle-dependent reduction of the base moment may also be achieved by means of a recess or a passage gap. In the case of a recess, with an intensification of the magnetic field, it is firstly the case that the gap sections (sealing gap and damping gap) are supplied with a more intense magnetic field, which leads to more intense interlinking of the MRF. With further increasing magnetic field, the material of the separating unit becomes saturated, such that finally the strength of the magnetic field in the recess increases. In this way, the free and effectively acting flow cross section is reduced and can be controlled in angle-dependent fashion. A base moment can be varied in angle-dependent fashion, because the base moment is dependent on the available (effective) flow cross section. Analogously, in the case of a passage gap, an (effective) flow cross section can be set.

If the magnetic field strength changes, the interlinking in the “holes” (recess or passage gap) changes. The magnetic field in the recesses or passage gaps closes with increasing magnetic field strength. This means that a reduction of the effective (free) flow cross section occurs. The structural cross sections therefore themselves do not change, but the effectively acting cross sections change even without structural measures.

In the case of a wide axial passage gap, it is also possible for an inhomogeneous magnetic field over the gap width to be generated, such that setting of the effective flow cross section is possible by means of the intensity and inhomogeneity of the acting magnetic field. If for example two separate electrical coils are used, of which in each case one is arranged at or adjacent to an axial end of the passage gap, then it is possible for a wide variety of magnetic field profiles of the gap width to be set by means of a variation of the two current intensities of the electrical coils. In preferred developments, at both axial ends of the separating wall which is connected to the damper shaft, in each case one (end-side) axial gap section or gap is formed between the housing and the separating wall. Preferably, at least a major part of the magnetic field of the magnetic field source passes through both axial gap sections between the housing and the separating wall and effects a seal of the two (end-side) axial gap sections. Said gap sections are then the third gap section and a fourth gap section. The axial gaps at both end sides are then sealed by means of the magnetic field. Control of the throughflow may also be influenced through control of the strength of the magnetic field at said sealing gaps. The throughflow is however influenced primarily by the one or more damping gaps or damping gap sections.

It is also possible for a non-rectangular separating unit to be used. For example, the separating units may be of semicircular form and received in a corresponding hemispherical receptacle in the housing. This then also results in gaps or gap sections with a (partially or predominantly) axial orientation and with a (partially or predominantly) vertical orientation. In the context of the present invention, two gap sections may also be understood to mean differently oriented sections of one continuous gap.

It is preferable for 2 electrical coils to be provided, which are in particular arranged in each case adjacent to the damper volume. It is preferable for in each case one controllable electrical coil to be assigned to in each case one axial gap. In particular, in each case one controllable electrical coil is accommodated in each case axially to the outside in the vicinity of an axial gap. The electrical coils can be controlled separately by means of one control device.

In all refinements, it is preferable for the magnetic field to run transversely with respect to at least one of the gap sections. In particular, the magnetic field runs transversely with respect to at least 2, 3 or more gap sections. A particularly intense action is attained by means of a magnetic field extending transversely with respect to the gap section. Here, the magnetic field may be oriented perpendicular to the gap section. The magnetic field may however also run obliquely through the gap section.

It is preferable for at least one radial gap section to be formed as a damping channel and to be arranged radially between the separating unit, which is connected to the damper shaft, and the housing. It is also possible and preferable for at least one axial gap section to be formed as a damping channel and to be arranged axially between the separating unit, which is connected to the damper shaft, and the housing.

It is particularly preferable for both the axial gaps and the radial gaps to be sealed off by means of the magnetic field of the magnetic field source.

It is preferable for at least a major part of the magnetic field of the magnetic field source to pass through the damping channel. It is particularly preferable if at least a major part of the magnetic field of the magnetic field source passes through all gap sections. A “major part” of the magnetic field is to be understood in particular to mean a proportion of >10% and preferably a proportion of greater than 25%.

In all refinements, it is also possible for at least one gap section to be sealed off by a mechanical sealing means. The task of the sealing means is to prevent or limit transfers of material and pressure losses/a pressure drop from one space into another. Such a mechanical sealing means may be a mechanical seal such as a sealing lip, sealing strip, flat seal, profiled seal, ground-in seal or an O-ring or square section ring or the like. For example, the gap section extending between the separating unit, which is connected to the housing, and the damper shaft may be sealed off by a mechanical sealing means, whereas the gap section between the separating unit, which is connected to the damper shaft, and the housing and the axial gap sections are subjected to the magnetic field of the magnetic field source in order to set the desired damping.

In all refinements, it is particularly preferable for the housing to comprise a first and a second end part and, in between, a middle part. Here, it is in particular also possible for the middle part to be composed of 2 or more separate sections. In particular, in each case one electrical coil is accommodated in at least one of the two end parts and in particular in both end parts. Here, an axis of the coil is in particular oriented substantially parallel to the damper shaft. In this way, a compact construction is attained, in the case of which an intense seal can be attained by means of the magnetic field of the magnetic field source.

Preferably, at least a major part of the housing is composed of a magnetically conductive material with a relative permeability greater than 100. In particular, the relative permeability is greater than 500 or greater than 1000. Here, it is possible for the entire housing, or else for a substantial or at least major part thereof, to be composed of such a material. It is particularly preferable for at least one of the housing sections adjoining the damper volume to be composed of a magnetically conductive material.

It is preferable for a (separate) ring to be arranged axially adjacent to the electrical coil in the housing. The ring is in particular arranged axially between the electrical coil and the damper volume.

It is possible for the ring and/or the electrical coil to be situated substantially, or virtually entirely or entirely, radially further to the outside than the damper volume. Preferably, the ring is situated axially adjacent to, and so as to join, a middle part of the housing. In such refinements, it is preferable for the ring to be composed at least substantially or entirely of a material with a relative permeability less than 10. The relative permeability of the ring material is in particular less than 5 or even less than 2. The ring is thus preferably composed of magnetically non-conductive materials. The ring may for example be composed of austenitic steels. The material of the ring has such a magnetic permeability that a magnetic short-circuit of the magnetic field of the magnetic field source is reliably prevented. In such refinements, the ring is in particular formed as a flat ring-shaped disk or as a hollow cylinder.

In other refinements, the ring and/or the electrical coil is (substantially) arranged not adjacent to the middle part of the housing. It is then possible and preferable for the ring and/or the electrical coil to be arranged radially further to the inside in relation to, and/or at least partially or entirely adjacent to, the damper volume. The ring may be formed as a hollow cylinder and in particular as a hollow frustum. The ring then has a smaller wall thickness radially to the outside than radially further to the inside. The cross section through the ring has an oblique profile. In such refinements, the ring is preferably composed of a magnetically conductive material. The relative permeability of the ring material is then preferably greater than 10 and particularly preferably greater than 50 and in particular greater than 100. The configuration is highly advantageous because, in this way, in the region of the electrical coil, possible leakage through the (axial) gap section is reliably prevented.

The ring preferably has the form of a frustum with a hollow cylindrical interior, and is composed of a magnetically conductive material. By means of such a refinement, in the case of an arrangement of the coil laterally adjacent to the damper volume, a leakage in the region of the coil is prevented, in particular if the acting magnetic field is sufficiently strong.

In all refinements, the damping is intensified by means of a magnetic seal of the axial gaps at the end sides. Furthermore, a pressure loss within the axial gap as a result of an overflow of magnetorheological fluid is prevented.

In all refinements, it is particularly preferable for the magnetorheological fluid to be conveyed through at least one (damping) gap from one chamber into the other chamber by means of a relative pivoting movement of the damper shaft and of the housing.

It is possible and preferable for 2 or more separating units which are arranged so as to be distributed over the circumference to be formed on the damper shaft. 2 or more separating units which are arranged so as to be distributed over the circumference are then preferably correspondingly formed on the housing. Preferably, the in each case one separating unit connected to the damper shaft interacts with a separating unit connected to the housing. By means of a multiplicity of separating unit pairs, the maximum acting braking moment can be increased.

If only one separating unit is formed on the damper shaft and only one separating unit is formed on the housing, the maximum possible pivot angle between the damper shaft and the housing is generally less than 360° or is (almost) 360°. If in each case 2 separating units are used, then the maximum pivot angle is up to (and generally somewhat less than) 180°. Accordingly, in the case of 4 separating units on the damper shaft and the housing, it is generally the case that only pivot angles less than 90°, or up to 90°, are possible. If high braking moments are demanded, and if only a limited pivot angle is required, then a corresponding rotary damper can be provided using simple means.

Preferably, in the case of a corresponding number of separating units, a corresponding number of chambers or chamber pairs is formed, of which, then, in the case of a pivoting movement, in each case one proportion forms a high-pressure chamber, whereas another proportion forms in each case one low-pressure chamber. Preferably, then, the high-pressure and low-pressure chambers are connected to one another by corresponding connecting channels, in order to thus provide a pressure equalization between the individual high-pressure chambers and the individual low-pressure chambers, respectively, at all times. The effectiveness of the rotary damper as a whole is not impaired by such connecting channels, because, theoretically, the same pressure should prevail at all times in all high-pressure chambers (low-pressure chambers). It has however been found that, by means of corresponding connecting channels, the functionality can be improved, and any tolerances can be compensated.

In preferred refinements, a compensating device with a compensating volume is provided. The compensating device serves in particular for allowing leakage and/or temperature compensation. By means of the compensating device, a volume equalization in the case of changing temperatures can be provided. Furthermore, improved long-term functionality can be ensured because, by means of a corresponding compensating volume, leakage losses can be compensated even over the long term without impairment of functionality.

In preferred refinements of all above-described embodiments and refinements, the compensating volume is connected by means of a valve unit to the two chambers (high-pressure side and low-pressure side). Here, the valve unit is preferably designed to produce a connection between the compensating volume and a low-pressure chamber and block a connection between the compensating volume and the high-pressure chamber. In simple refinements, this functionality is provided by means of a double valve of a valve unit, wherein the two valves of the valve unit each close when a higher pressure prevails in the adjoining chamber than in the compensating volume. This has the effect that volume is automatically conveyed out of the compensating volume or conveyed into the compensating volume if the pressure in the respective low-pressure chamber decreases or increases respectively.

In preferred refinements, the compensating device, or a part of the compensating device, is accommodated in the interior of the damper shaft. This saves structural space. In particular, the damper shaft has a cavity in the interior. The cavity is preferably accessible from (at least) one axial end of the damper shaft. In particular, at least one part of the cavity, or the entire cavity, is formed as a hollow cylinder of circular or regular form. In the hollow cavity or hollow cylinder, there is preferably formed a running surface for a separating piston for the purposes of separating an air or fluid chamber from a compensating volume, which is in particular filled with MRF. The compensating volume is preferably connected by means of at least one connecting channel to at least one chamber in order to provide a volume compensation in the event of, for example, temperature fluctuations or in the event of leakage losses of MRF.

In all refinements and developments, the damper shaft may be of single-part form. In preferred refinements, the damper shaft is of two-part or three-part or multi-part form. Preferably, the two, three or more parts are connectable or couplable to one another so as to be rotationally conjoint. In one refinement, in which a compensating device is accommodated in a hollow part of the damper shaft (hollow shaft), as described above, there is preferably provided an attachment shaft which is axially connected, and coupled rotationally conjointly, to the hollow shaft. The attachment shaft and the hollow shaft may preferably be axially screwed together.

In all refinements, it is preferred that at least one channel leads from the inside to the surface of the housing, which channel is connected at the inside to at least one chamber and can be closed at the outer end for example by means of a closure. An external compensating device can then be attached externally as required. Any cavity present in the interior of the damper shaft can be filled by means of an insert.

Preferably, at least one sensor and in particular at least one angle sensor and/or at least one travel sensor is provided on the housing. In preferred refinements, an absolute angle or travel sensor and/or a relative angle or travel sensor may be provided. By means of a, for example, relatively inaccurate absolute sensor, it is then always the case that an approximate value is available, whereas, with the relative sensor, it is then the case during an occurring movement that an exact value is ascertained, which can then be used. In this way, it is always the case that, for example after a deactivation, an “approximately” correct value is available with which the control can initially be commenced.

On the housing and in particular on an outer side of the housing, there is preferably formed at least one mechanical stop, which interacts with the damper shaft and which provides an effective rotational angle limitation without the separating walls assuming a block state. This facilitates the mechanical configuration of the strength of the components.

In all refinements, it is preferred that a temperature sensor is provided for detecting a temperature of the magnetorheological fluid. By means of such a temperature sensor, control adapted to the presently prevailing temperature can be performed, such that the rotary damper always exhibits the same characteristics independently of the temperature of the magnetorheological fluid.

In all refinements, it is particularly preferable that the damping circuit of the magnetorheological fluid is arranged entirely within the housing. In this way, a particularly simple and compact construction is made possible.

Preferably, an angle sensor is provided in order to detect a measure for an angular position of the damper shaft. In this way, angle-dependent control of the damping is possible. For example, increased damping may be set in the vicinity of an end position.

In all refinements, it is preferred that a load sensor is provided for detecting a characteristic value for a torque on the damper shaft. In this way, load-dependent control can be performed in order, for example, to optimally utilize the remaining available damper travel.

In all refinements, it is also preferable that at least one sensor device is included, which at least one position and/or spacing sensor serves for detecting a position and/or a spacing of and/or to surrounding objects. Here, the control device is preferably designed and configured to control the rotary damper in a manner dependent on the sensor data from the sensor device.

An apparatus according to the invention comprises at least one rotary damper as described above. Such an apparatus may be designed as a machine or as a stabilizer or for example as a winding appliance or as a spooling machine or as a weaving machine or other machine. The use on other machines and installations is also possible and preferred. Accordingly, an apparatus according to the invention may also be designed as a door device or as a safety steering column of a motor vehicle. An apparatus according to the invention comprises 2 units which are movable relative to one another and at least one rotary damper as has been described above.

In a preferred development, the apparatus comprises a control device and a multiplicity of interconnected rotary dampers.

In particular, an apparatus with multiple interlinked rotary dampers makes a wide range of applications possible.

In all refinements, the rotary damper allows widely varied use. A considerable advantage of the rotary damper according to the invention consists in that the displacement device is provided with a magnetorheological fluid as working fluid. In this way, in a manner controlled by a control device, the magnetic field of the magnetic field source can be set in real time, that is to say in a few milliseconds (less than 10 or 20 ms), and thus the braking moment acting on the damper shaft is also set in real time.

The rotary damper has in particular a displacement device. The displacement device has a damper shaft and rotating displacement components. Here, a rotational movement of the damper shaft can be dampened (in controlled fashion). The displacement device contains a magnetorheological fluid as working fluid. It is assigned at least one control device. Furthermore, at least one magnetic field source is provided or included, which has at least one electrical coil. The magnetic field source is controllable by means of the control device, and, by means of the magnetic field, the magnetorheological fluid can be influenced in order to set a damping of the rotational movement of the damper shaft.

Such a rotary damper is highly advantageous in an apparatus. One advantage consists in that the displacement device is provided with a magnetorheological fluid as working fluid. In this way, in a manner controlled by the control device, the magnetic field of the magnetic field source can be set in real time, that is to say in a few milliseconds (less than 10 or 20 ms), and thus the braking moment acting on the damper shaft is also set in real time, if the rotary damper is to impart a corresponding braking moment. The construction of the rotary damper is simple and compact and requires few components, such that the rotary damper can be produced, and integrated into the apparatus, in an inexpensive manner.

The construction of the rotary damper according to the invention is simple and compact and requires few components, such that the rotary damper itself can be produced inexpensively as a (high-volume) series production part. In all refinements, it is possible and preferred for the magnetic field source to comprise at least one (additional) permanent magnet. By means of a permanent magnet, a targeted static magnetic field can be generated, for example in order to generate, or make available, a base moment of a particular magnitude. This magnetic field of the permanent magnet can be strengthened or weakened in targeted fashion by means of the electrical coil of the magnetic field source, such that the magnetic field can preferably be set as desired between 0 and 100%. This results in a corresponding braking moment, which can likewise preferably be set between 0% and 100%. In the case of a deactivated magnetic field or a magnetic field reduced to a low value, it is possible for a low or very low base moment to be generated.

It is possible and preferable for the magnetization of the permanent magnet to be permanently changed by means of at least one magnetic pulse of an electrical coil. In the case of such a refinement, the permanent magnet is influenced by magnetic pulses of the coil such that the field strength of the permanent magnet is permanently changed. Here, the permanent magnetization of the permanent magnet by means of the magnetic pulse of the magnetic-field generating device can be set to any desired value between zero and the remanence of the permanent magnet. The polarity of the magnetization is also variable. A magnetic pulse for setting a magnetization of the permanent magnet is in particular shorter than 1 minute and preferably shorter than 1 second and particularly preferably the duration of the pulse is less than 10 milliseconds.

As an effect of a pulse, the form and strength of the magnetic field in the permanent magnet is permanently maintained. The intensity and form of the magnetic field can also be changed by means of at least one magnetic pulse of the magnetic field generating device. A de-magnetization of the permanent magnet can be performed by means of a dampened magnetic alternating field.

A suitable material for such a permanent magnet with changeable magnetization is for example AlNiCo, though use may also be made of other materials with similar magnetic characteristics. It is furthermore possible, instead of a permanent magnet, for the entire magnetic circuit or parts thereof to be produced from a steel alloy with strong residual magnetism (high remanence).

It is possible by means of the permanent magnet to generate a permanent static magnetic field, which may also have a dynamic magnetic field of the coil superimposed thereon in order to set the desired field strength. Here, the present value of the field strength can be varied as desired by means of the magnetic field of the coil. The use of two separately actuatable coils is also possible.

In all refinements, it is preferable for the permanent magnet to be composed at least partially of a hard magnetic material, the coercive field strength of which is greater than 1 kA/m and in particular greater than 5 kA/m and preferably greater than 10 kA/m.

The permanent magnet may be composed at least partially of a material which has a coercive field strength less than 1000 kA/m and preferably less than 500 kA/m and particularly preferably less than 100 kA/m.

In all refinements, it is preferable for at least one energy store to be provided. In particular, the energy store is rechargeable. The energy store is in particular of mobile form and may be arranged on or even integrated into the rotary damper. For example, the energy store may be in the form of an accumulator or battery.

The rotary damper may also serve for the damping of a rotational movement between 2 components, wherein, for example, a rotational movement of an automobile door or of a tailgate of a motor vehicle or of a wing door or of an engine hood is dampened. Use on a machine for the purposes of damping rotational movements thereon is also possible.

The rotary damper described here can be of extremely compact construction and be produced very inexpensively. Owing to the magnetic seal by means of the magnetorheological fluid, an intense sealing action can be attained. Maximum pressures of 100 bar and higher are attainable.

In the case of the rotary damper according to the invention, the force profile can be controlled in stepless and variable fashion and very quickly by means of the current applied to the electrical coil.

If a rotary damper is used for damping the rotational movement of a door or of other components, then it is not necessary to use a transmission to brake the door during the opening or closing movement. Owing to the high possible braking moment, the rotational movement of the door can be directly dampened. This increases the sensitivity or the haptic characteristics of the door.

The rotary damper may advantageously also be linked to a computer in order to set the rotary damper or the appliance and/or log the operation thereof. The ideal setting is then programmed in the computer.

It is then possible for a conversion of movement from rotational into linear or vice versa into other forms of movement to be realized by means of levers. Use on mine protection seats is also possible.

The invention may be used in a wide variety of appliances. Here, conventional linear dampers are possibly replaced by means of the rotation dampers according to the invention, which are connected directly or indirectly to parts of the appliance or of the apparatus. For example, the rotary damper may be attached at a center of rotation and operatively connected to the limbs. Preferably, the rotary damper is also simultaneously the bearing point for the pivoting part. In this way, a very compact and inexpensive design is attained.

Such a rotary damper of shallow construction is highly advantageous.

The spring may, as a torsion spring, spiral spring, leaf spring or air/gas spring, be operatively connected to other parts.

Use in an apparatus is possible, wherein the rotary damper is arranged between 2 components, which are adjustable relative to one another and in particular rotatable relative to one another, of the apparatus. Here, one component is coupled to a first side and the other component is coupled to the other side, such that a relative rotation of the components with respect to one another can be dampened, completely decoupled or set in a manner controlled by means of the rotary damper. In this way, an active apparatus can be provided which can be set for different conditions. Preferably, the two halves are coupled in the electrically deenergized state (for example by means of a permanent magnet or remanence in the magnetic field circuit) and are decoupled as desired by means of electrical current.

By means of the features according to the invention, large pressure drops can be attained, even in the case of complex contours and contour transition or contour transitions, with little technical outlay and low costs.

A further rotary damper that the applicant reserves the right to claim protection for comprises a housing, at least one magnetic field source and a damper volume which is provided with a magnetorheological fluid and which is divided by at least one separating unit, which is connected to a damper shaft, into at least two (variable) chambers. Gap sections are formed between the separating unit and the housing. At least one magnetic field source with at least one controllable electrical coil is included. The housing, the magnetic field source and the separating unit are designed and configured such that an effective flow cross section between the two chambers can be varied in an angle-dependent manner by mechanical means such as a bypass or a projection, or that an effective flow cross section can be varied in an angle-dependent manner through control of the magnetic field of the magnetic field source.

It is preferable if a magnetic field of the magnetic field source flows through the main gap sections between the separating unit and the housing. In particular, an intensity of the damping is set in a manner dependent on a strength of the magnetic field.

Preferably, at least one separating unit is provided which is connected to the housing. In particular, a gap section between the separating unit and the shaft is formed which can be flowed through by the magnetic field of the magnetic field source.

In particular, the separating unit connected to the shaft is formed as a pivot vane.

Advantageously, a radial damping gap and two axial sealing gaps are formed between the pivot vane and the housing.

Preferably, in addition to the gap sections (sealing gaps and damping gaps), in the wall surrounding the damper volume, there is formed a bypass which connects the two adjacent chambers to one another in at least one angle range.

Preferably, in addition to the gap sections (sealing gaps and damping gaps) on the separating unit, there is formed at least one recess which connects the two adjacent chambers to one another in at least one angle range.

Preferably, at least one gap section comprises at least one first region and at least one second region, wherein a gap height is considerably greater in the second region than in the first region.

In a method for damping movements, which the applicant reserves the right to claim protection for, by means of a rotary damper, the rotary damper has at least one magnetic field source and a damper volume which is provided with a magnetorheological fluid and which is divided by at least one separating unit which is connected to the damper shaft. Gap sections are formed between the separating unit and the housing. The main gap sections between the separating unit and the housing are (as required) flowed through by a magnetic field of the magnetic field source in order to influence the damping and in particular set an intensity of the damping. The magnetic field source comprises at least one controllable electrical coil and controls an intensity of the damping by means of the strength of the magnetic field. An effective flow cross section is changed considerably during a rotational movement of the damper shaft relative to the housing.

Preferably, for this purpose, the electrical coil or the present electrical coils (in particular in addition to mechanical refinements as described above) is or are controlled such that the effective flow cross section changes in an angle-dependent manner. This can be achieved for example by means of saturation effects in the separating unit, whereby regions or sections of, for example, recesses or passage gaps which are initially flowed through with much lesser intensity by the magnetic field are flowed through by a considerably stronger magnetic field with increasing current intensity. In this way, the local throughflow resistance increases, and the effective flow cross section decreases.

The controlled magnetic field preferably acts in the main gap sections simultaneously. In this way, not only is the damping controlled, but the intensity of the seal is also controlled, and thus the base moment is varied. The base moment is thus considerably lower in the case of low magnetic field strengths.

It is basically possible for permanent magnets to be used for gap sealing with MRF in any situation, as described in U.S. Pat. No. 6,318,522 B1. Here, one permanent magnet or multiple permanent magnets may be used. These basically act as mechanical (rubber) sealing elements. This also extends to a pivoting component and also at the inside in the pressure region. Such a seal is also possible on rectangular surfaces. Such a seal is not possible, or is not so easily possible, with electrical coils, because these must be integrated practically “in the middle” into the magnetic field circuit. Preferably in the unpressurized region and with fixed cables and circular as a wound part. The attachment is thus much more complicated than in the case of permanent magnets. This is the case in particular if it is sought to influence in each case more than one gap, or even all gaps, with the fewest possible electrical coils. In the case of the present invention, the coils are not exposed to pressure and can be wound normally. Overall, the construction is very simple and can be produced inexpensively. Furthermore, the base moment changes with the intensity of the generated magnetic field. In the case of an only very weak magnetic field, or in the absence of a magnetic field, there is very low friction, because the gaps are large.

In all embodiments, the pivot angle can be varied by means of the number of separating units or the number of vanes. In the case of one separating unit, a pivot angle of approximately 300 degrees is attained. In the case of two separating units, the pivot angle is approximately 120 degrees, and in the case of four vanes, it is approximately 40 degrees. The more separating units are provided, the greater the transmissible moment.

It is also possible for two or more separating units (pivot vanes) to be positioned in series, that is to say cascaded. A single separating unit allows a pivot angle of approximately 300 degrees. If one connects the output shaft to the housing of a second rotary damper, one achieves 600 degrees at the output shaft of the second rotary damper. In applications which require more than 300 degrees, it is thus possible to increase the pivot angle. This can, with suitable nesting, be realized in a structural-space-saving manner.

Passage gaps may also be referred to as fans or fan gaps. Such passage gaps or fan gaps also have a positive effect on the residual magnetic field characteristics (remanence). The greater the number of passage gaps provided, the lesser the residual magnetic field, because this is weakened by means of the (air) gaps.

The (magnetic) remanence, also referred to as remanent or remaining magnetism, residual magnetism or residual magnetization, is to be understood to mean the magnetization that a particle that has previously been magnetized into a saturated state (that is to say to a maximum extent) by means of an external magnetic field H, for example by means of a coil flowed through by electrical current, maintains after the withdrawal of the external field.

Further advantages and features of the present invention will emerge from the description of the exemplary embodiments, which will be discussed below with reference to the appended figures, in which:

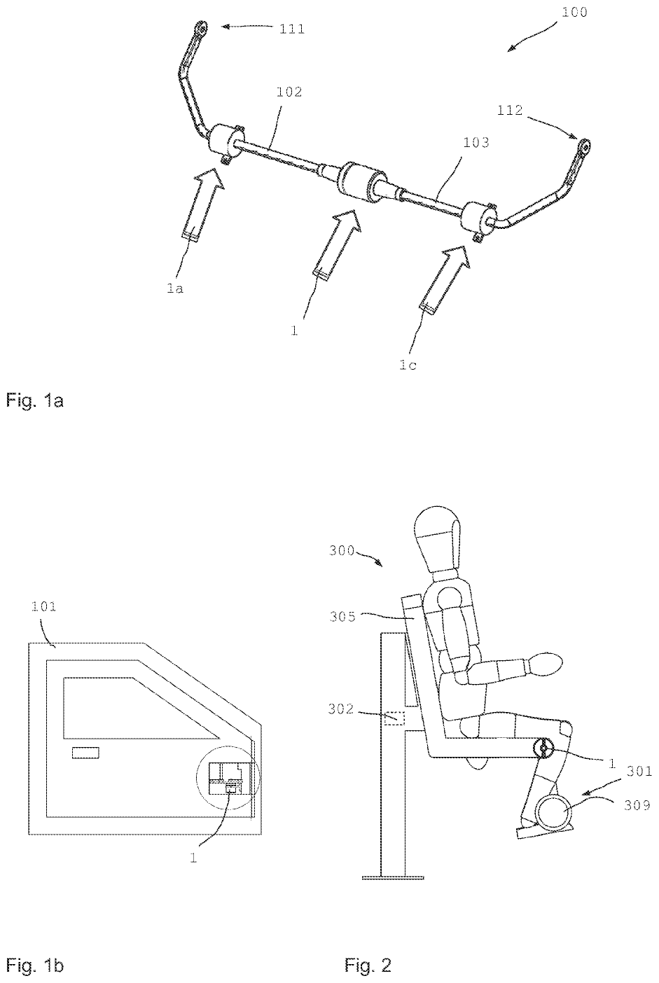

FIG. 1a shows a stabilizer with a rotary damper according to the invention;

FIG. 1b shows an automobile door with a rotary damper according to the invention;

FIG. 2 shows a fitness appliance with a rotary damper according to the invention;

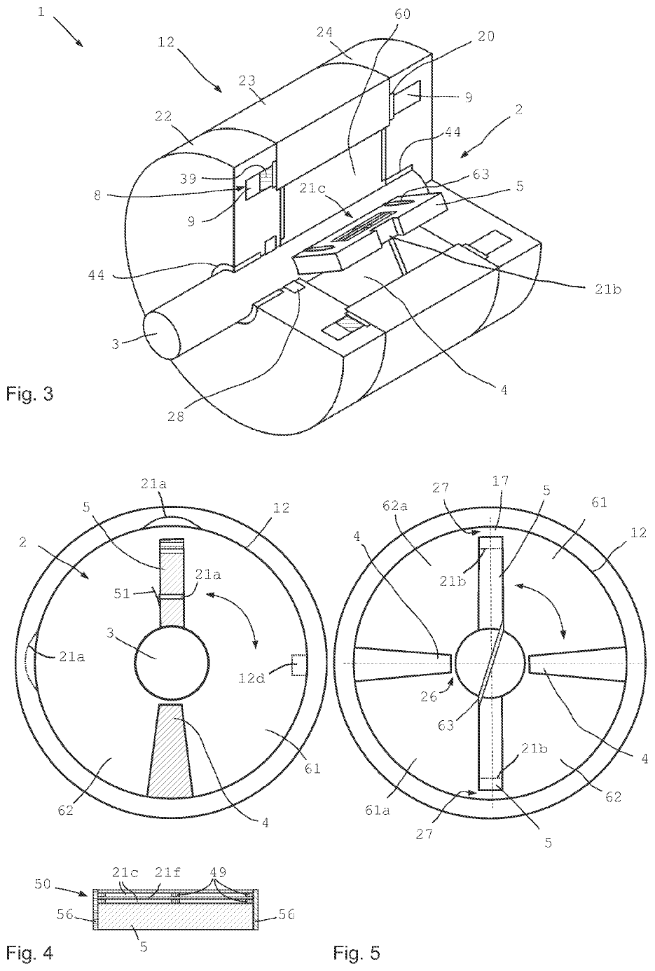

FIG. 3 shows a partial section through a rotary damper according to the invention;

FIG. 4 shows a schematic section through a rotary damper according to the invention;

FIG. 5 shows a section through another rotary damper according to the invention;

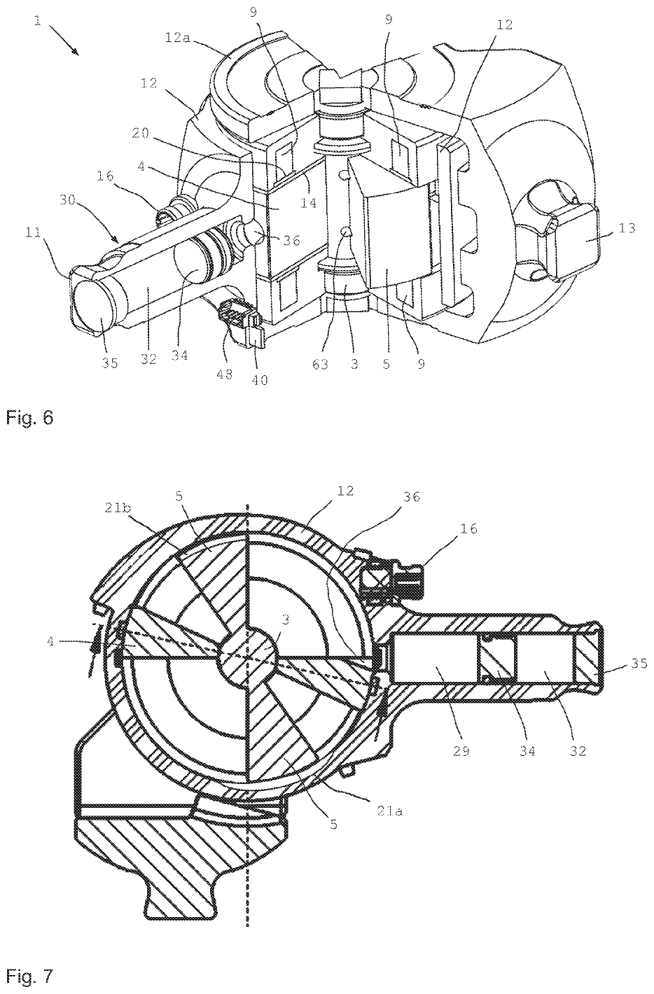

FIG. 6 shows yet another exemplary embodiment of the rotary damper according to the invention in partial section;

FIG. 7 shows a section through the rotary damper as per FIG. 6;

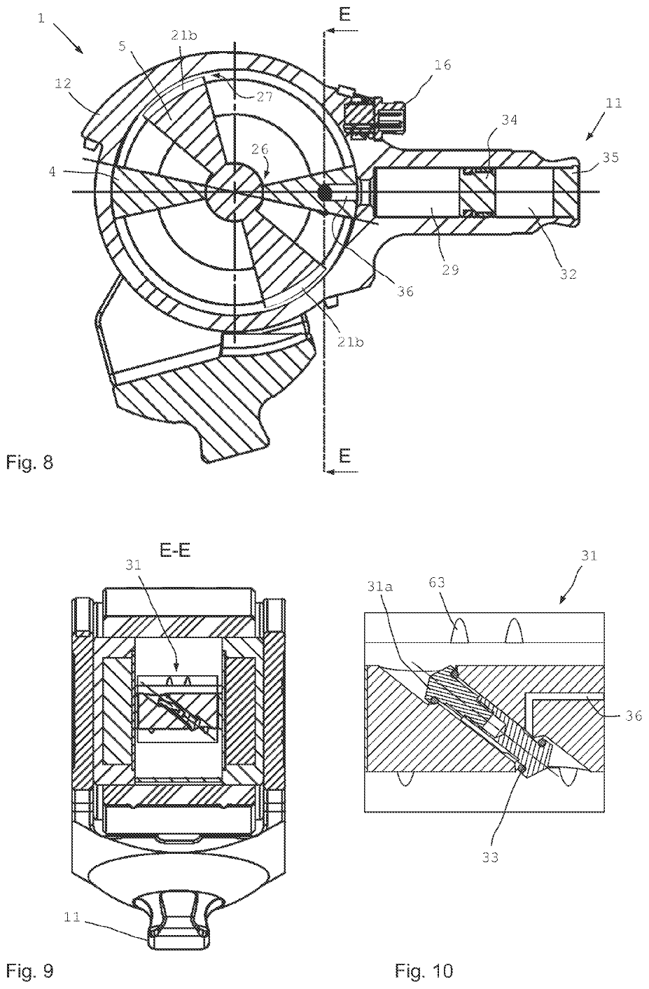

FIG. 8 shows a section through another rotary damper;

FIG. 9 shows the section B-B from FIG. 8;

FIG. 10 shows an enlarged detail from FIG. 9;

FIG. 11 shows a cross section through a rotary damper according to the invention, with a magnetic field profile plotted;

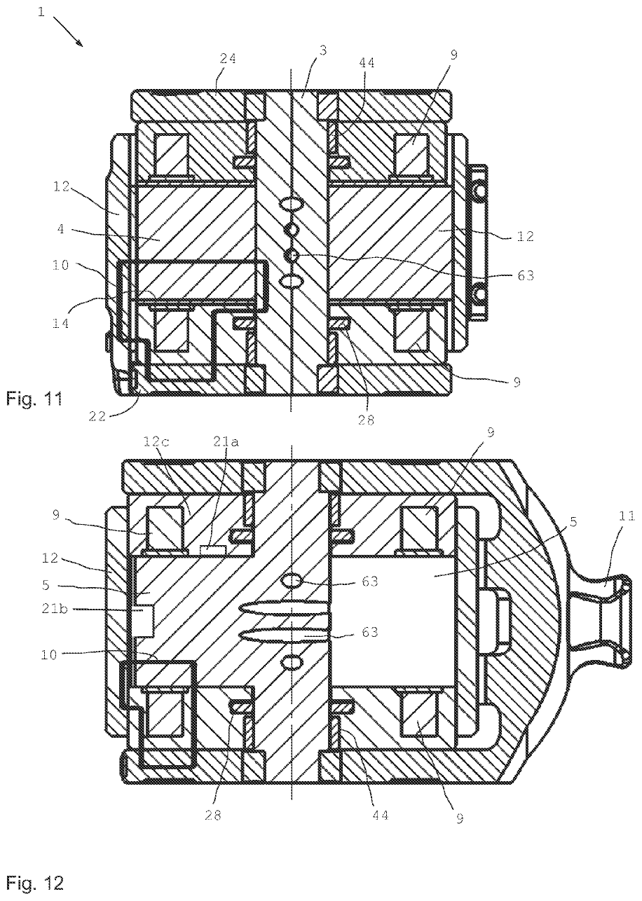

FIG. 12 shows another cross section through the rotary damper as per FIG. 11, with a magnetic field profile plotted;

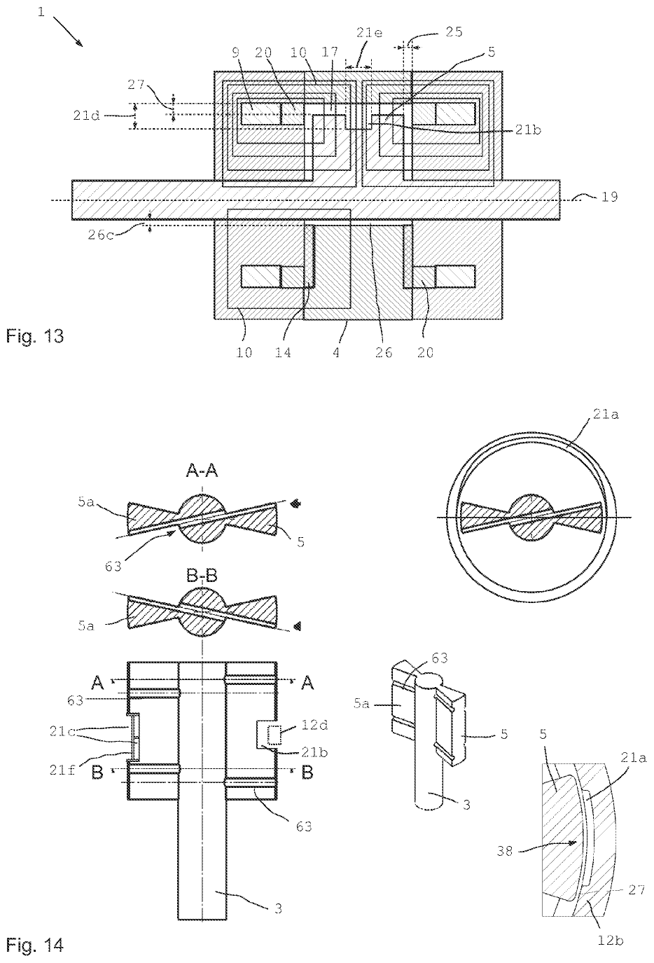

FIG. 13 shows a schematic cross section through a rotary damper according to the invention;

FIG. 14 shows a damper shaft for a rotary damper in various views;

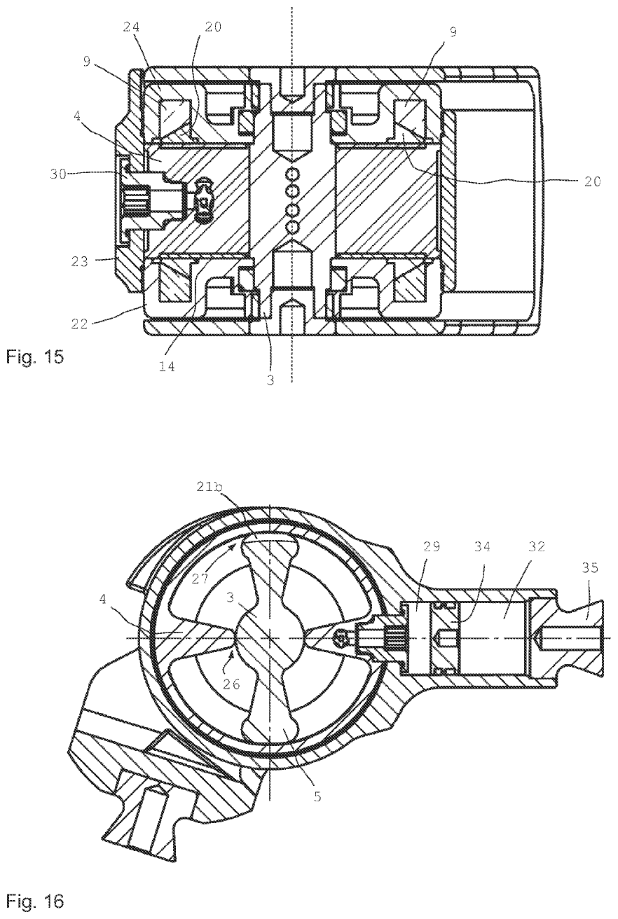

FIG. 15 shows a section through yet another rotary damper;

FIG. 16 shows a schematic cross section through a further rotary damper according to the invention;

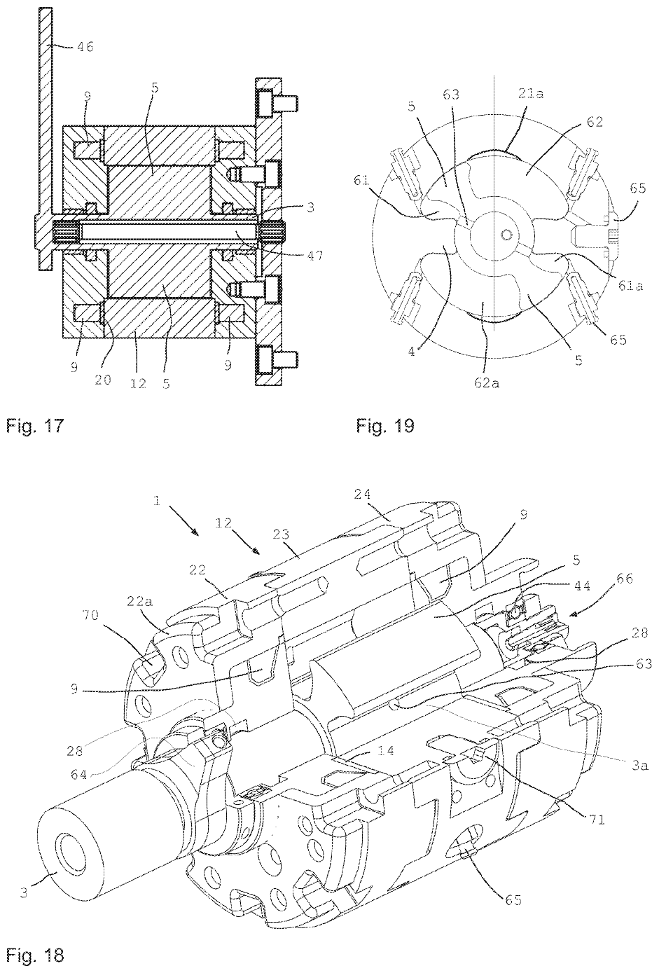

FIG. 17 shows a rotary damper according to the invention with a torsion bar;

FIG. 18 shows a partial section through a further rotary damper according to the invention;

FIG. 19 shows a cross section through the rotary damper as per FIG. 18;

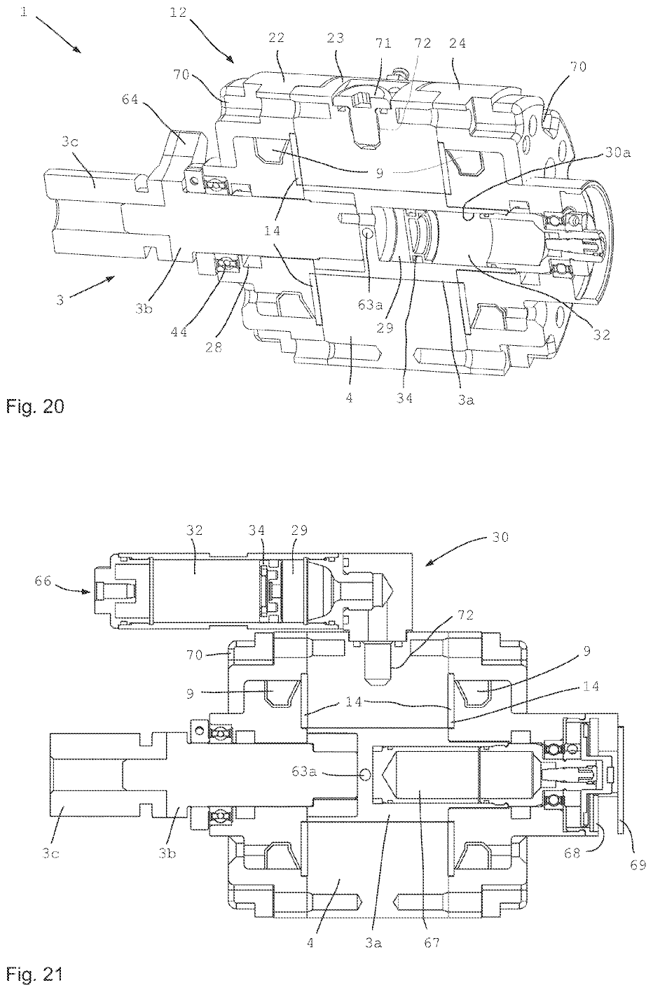

FIG. 20 shows a longitudinal section through the rotary damper as per FIG. 18; and

FIG. 21 shows an alternative embodiment of the rotary damper as per FIG. 18.

FIG. 1 shows an exemplary embodiment of an apparatus according to the invention as a chassis component, which is in this case in the form of a stabilizer 100 for a motor vehicle. Various embodiments are basically possible here.

In a simple embodiment, only one rotary damper 1 is provided, specifically in this case the rotary damper 1. The components denoted by 1a and 1c then serve only for the mounting of the two stabilizer rods 102 and 103 on the body of a vehicle, such as for example a passenger motor vehicle or a heavy goods vehicle or some other vehicle, and possibly have no further function. The use is also possible on special purpose vehicles or tanks or the like.

In a particularly simple embodiment, the first stabilizer rod 102 is connected by means of its distal end 111 directly or indirectly, and at least indirectly, to a first wheel of the vehicle. Correspondingly, the second stabilizer rod 103 is connected by way of its distal end 112 to a second wheel of the vehicle.

The two stabilizer rods 102 and 103 are connected to the rotary damper 1, wherein one of the two stabilizer rods 102, 103 is coupled rotationally conjointly to the damper shaft 3 (cf. FIG. 3), and wherein the other of the two stabilizer rods 103, 102 is connected to the housing 12 (cf. FIG. 3).

The rotary damper 1 is connected not rotationally conjointly to the body. The rotary damper 1 serves for damping a rotational movement of the two stabilizer rods 102, 103 with respect to one another. Such a relative movement occurs during straight-ahead travel of a motor vehicle, for example if only one wheel travels over an obstruction or through a pothole and is accordingly raised or lowered. If the two stabilizer rods 102, 103 are coupled in a rotationally conjoint manner, this leads to a corresponding pivoting movement of the respective other stabilizer rod. During straight-ahead travel, this can lead to unsettled driving behavior, for which reason a decoupling or at least reduced coupling of the two wheels of a wheel axle may be advantageous in such cases. By contrast, during cornering, it is rather the case that coupling is desired.

The controllable rotary damper 1 as chassis component 100 is advantageous here because, by means thereof, an intensity of coupling of the two stabilizer rods 102, 103 can be controlled (in a sensitive manner). Depending on the intensity of a magnetic field of a magnetic field source 8 of the rotary damper, the magnetorheological fluid in the displacement device 2 of the rotary damper 1 can be influenced in order to set the coupling intensity of the two stabilizer rods 102, 103.

Here, an (approximately) complete decoupling can be set, in the case of which only a very low base moment acts. It is also possible for an (approximately) rigid connection to be set, in the case of which only the possibly low torsion action of the stabilizer rods 102, 103 acts.

It is thus possible with the chassis component 100 for the left wheel side to be decoupled from the right wheel side. Multifunctional spring rate switching and/or ride height adjustment can be achieved. A ride height adjustment is also possible by means of the sawtooth principle and the freewheel principle with utilization of the body movement.

In a first embodiment, torques of up to and greater than 1000 Nm are attained, wherein the maximum pivot angle is greater than 25° and may reach 30° or more.

One advantage is that a simple construction is realized. The rotary damper practically forms a direct MRF coupling, that is to say two components of the actuator which pivot relative to one another generate the torque, without the use of a transmission. The system is simple, robust and free from play. Here, only a relatively low weight of approximately 2500 to approximately 4000 g is required. The length of the rotary damper is approximately 150 mm in the case of a diameter of (approximately) 85 mm. The operating voltage can be selectable.

It is highly advantageous that switching times=<10 ms for the switching from a minimum to a maximum are achievable. In this way, it is possible to react to potholes, for example, during travel. The working range may be variable and, in one example, amounts to between approximately 50 Nm and 1000 Nm, and may also be greater or smaller.

Not only is a maximum coupling or a release possible, but also, any desired number of (intermediate) switching positions is selectable by means of a variation of the electrical current.

As shown in particular by FIGS. 3, 4 and 5, the base moment of a stabilizer 100 and also of other rotary dampers 1 can be lowered, because, at least in a basic position 80 or else in other predetermined angle positions or angle ranges, an (effective) flow cross section is enlarged. This can be ensured for example by means of a bypass which acts only in the basic position or in a defined angle range about the basic position. Here, the cross section of the bypass can be kept substantially free from a magnetic field in order to attain an intense action of the bypass. Such a refinement is advantageous for example if a motor vehicle travels over cobblestones and small shocks are continuously exerted on each wheel, in the case of which it is advantageous for each shock to be individually dampened. For this purpose, a low base moment is advantageous because, in this way, an intense decoupling of the wheels in the case of small shocks is attained.

In another embodiment, three rotary dampers 1 may be used on the chassis component 100, specifically at the locations 1, 1a and 1c. Here, the rotary damper 1 operates as described above, and selectively couples the two stabilizer rods 102, 103 to one another in a more or less rotationally conjoint manner.

If only the rotary damper 1b is active, a classic stabilizer function is realized, wherein, however, an opening (deactivation) of the rotary damper 1b decouples the left-hand wheel side with respect to the right-hand wheel side.

FIG. 1b shows a further exemplary embodiment of the invention, and in this case a door 101 of a vehicle and in particular motor vehicle, wherein the door 101 is equipped, at the pivot joint, with a rotary damper 1 according to the invention, which can dampen the movement of the door 101 between the open and the closed position. Depending on the refinement, it is possible for the rotary damper 1 to be attached directly on the pivot axis. It is however also possible for the rotary damper 1 to be connected by means of a kinematic mechanism to the parts which pivot relative to one another.

FIG. 2 shows a training appliance 300 in the form of a leg extension apparatus. During the training process, the person performing the training is situated on a seat 305 and raises an at the lever 309 by extending the legs or the knees. The leg lever 309 serves here as actuating element 301, and is attached pivotably to the seat 305. The pivoting movement can be dampened here by means of a damper device 1. Here, by way of example, the rotary damper 1 already illustrated in FIGS. 1a, 1b and 2, which will be discussed in even more detail with reference to the further figures, serves as damper device 1.

FIG. 3 shows a partial section of the rotary damper, which is used in principle in the example from FIGS. 1a, 1b and in the example according to FIG. 2. The rotary damper 1 has a housing 12 and a damper shaft 3, which are formed so as to be pivotable relative to one another. The damper shaft 3 is mounted rotatably in the housing 12 by means of plain bearings 44. The housing 12 is composed here of three sections or housing parts, specifically a first end part 22 and a second end part 24 at the other end and a middle part 23 arranged in between. Here, each part or each region constitutes a separate component, which components are connected to one another during the assembly process. It is however also possible for the three housing sections or regions to be part of a single component, or to form two components.

In the two end parts 22 and 24, there is accommodated in each case one encircling electrical coil 9, which serves for the generation of the magnetic field required for the damping. The interior space of the rotary damper 1 provides a damper volume 60. In the housing, there is formed a displacement device 2 which comprises separating units 4 and 5. The separating units 4 and 5 divide the damper volume 60 into two or more chambers 61 and 62. Here, the separating unit 4 is formed as a separating wall and is fixedly connected to the housing 12. The separating unit 5 is likewise formed as a separating wall or as a pivot vane and is fixedly connected to the damper shaft 3. Preferably, the separating unit 5 is formed in one piece with the damper shaft 3. The damper volume 60 is in this case filled with magnetorheological fluid 6. A seal of the damper volume 60 to the outside is realized by means of a seal 28 in the housing part 22. During a pivoting movement, the separating units 4 and 5, which are rotatable relative to one another, displace the magnetorheological fluid (MRF) contained in the damper volume, such that the MRF partially flows over from one chamber into the other.

The magnetic field source 8 in the housing part 22 is composed here of electrical coils 9 and may furthermore comprise at least one permanent magnet 39, which are in particular in each case of ring-shaped form and accommodated in the housing part 22. Here, in the exemplary embodiment, electrical coils 9 and possibly also permanent magnets 39 are provided in both end parts. The permanent magnet 39 predefines a particular magnetic field strength which, by means of the electrical coil 9, can be modulated and thus eliminated or intensified.

Here, two separating units 4 project radially inward into the damper volume 60 from the housing. The separating units 4 form separating walls and thus limit the possible rotational movement of the damper shaft 3, on which likewise two separating units 5 are formed, which project radially outward from the damper shaft. Rotation of the damper shaft 3 causes the separating walls of the separating units 5, which in this case form pivot vanes, to be pivoted.

The electrical coils 9 are in this case, in the exemplary embodiment, arranged radially relatively far to the outside and, in this case, are delimited axially to the inside in each case by a ring 20 which exhibits no or poor magnetic conductivity and which serves for shaping the magnetic field profile. The ring 20 has a hollow cylindrical form.

Here, in the separating units 5, it is possible to see connecting channels 63, which will be described in more detail in the explanation of FIGS. 5 and 14.

Here, in the separating unit 5, there is shown a recess 21b, which practically provides a bypass for the magnetorheological fluid 6. The magnetorheological fluid 6 can, in the presence of low magnetic field strengths, pass over practically without disruption through the wall of the separating unit 5 from a chamber 61 into the chamber 62. The base moment is considerably reduced by means of the recess 21b. If a magnetic field is generated by means of the electrical coils 8, initially only the axial and radial gap sections 25, 27 are charged, because the magnetic resistance in the considerably taller gap at the recess 21b is considerably greater. With increasing magnetic field, saturation occurs in the wall of the separating unit 5, and with yet further increasing magnetic field, the cross section of the recess 21b is finally also charged with an increasingly stronger magnetic field. As a result, the proportion of the cross section of the recess 21b that provides a type of bypass decreases.

Overall, it is thus possible for a relatively low base moment to be provided at any desired angle positions, whereas a high braking moment can also be generated in the same or other angle ranges.

Alternatively and/or in addition, passage gaps 21c can be formed on the wall of the separating unit 5, which passage gaps connect the two sides to one another. Here, it is preferably possible for multiple parallel passage gaps 21c to be formed, which are separated from one another by thin magnetically conductive webs 21f. In the case of such a refinement, too, a very low base moment is provided in the absence of a magnetic field. A high braking moment can be generated. Through different actuation of the two electrical coils 8, it is possible for (effective) flow cross sections of different size to be provided.

It is possible for at least one passage gap 21c and at least one recess 21b to be combined, or else for only in each case one type to be used.

FIG. 4 shows a cross section through a rotary damper 1 of simple construction. Here, the displacement device comprises only one (single) separating unit 4, which extends radially inward from the housing into the damper volume 60. The damper shaft 3 is accommodated rotatably in the interior of the housing, on which damper shaft in this case also only one separating unit 5 extends radially outward. By means of the separating units 4 and 5, which serve as separating walls, of the displacement device 2, the damper volume 60 is divided in variable fashion into two chambers 61 and 62. In the event of a clockwise rotation of the damper shaft, the volume of the chamber 61 is reduced in size and the volume of the chamber 62 is increased in size, whereas, in the event of an opposite rotational movement, the volume of the chamber 61 is correspondingly increased in size.

On the separating unit 5, radially at the outside, there are formed multiple fan-like passage gaps 21b which are separated from one another by thin webs 21f.

It is also possible for a bypass 21a with a one-way valve 51 to additionally be provided in order to configure the flow resistance to differ in the different flow directions.

In the outer wall, local bypasses 21a can be formed at particular angle positions 38, which bypasses considerably reduce the base moment for example in a basic position 80, because the flow cross section that is available in the absence of a magnetic field is considerably enlarged, and is enlarged for example by 50% or 100% or by a factor of 2, 3 or 4 or more.

A lug or a projection 12d or the like may project radially inward, which lug or projection limits the available cross section in particular angle positions. This is a possibility for example if one recess 21b is provided and it is the intention for the base moment not to be reduced at a particular angle or in a particular angle range.

Below FIG. 4, an enlarged detail in an axial cross section is shown, showing the region of the passage gaps 21c. The passage gaps 21c may be part of an insert 50, which is attached as a whole to the separating unit 5. It is possible for multiple webs 21f and holders or spacers 49 to be provided, which collectively form the insert 50 and can be preassembled. Permanent magnets 56 may be arranged laterally, which permanent magnets generate a stray field in order to seal off lateral axial gap sections 25. It is also possible for thin magnetically conductive or magnetically poorly conductive regions, which quickly saturate, to be provided there. Such an insert may for example also be used in FIG. 3.

Multiple passage gaps separated from one another by webs form a “fan”. The cross-sectional area is increased overall. This reduces the base friction. The passage gaps may however also be closed entirely, because a homogeneous magnetic field is possible. A slight disadvantage is the higher electrical current requirement, which however is not of importance in many apparatuses, also because it is nevertheless the case that altogether only very little energy is required for operation.

It would also be possible for multiple metal sheets to be stacked one on top of the other and laterally connected and for example welded or adhesively bonded. It is possible for passage gaps or recesses to be produced for example by erosion etc.

FIG. 5 shows a cross section through another exemplary embodiment, wherein, in this case, in each case two separating units are fastened to the housing and to the damper shaft 3. The in each case symmetrically arranged separating units 4 and 5 thus allow a pivoting movement of the damper shaft 3 through almost 180°. Two chambers 61 and 61a and 62 and 62a are formed between the individual separating units 4 and 5. If the damper shaft 3 is rotated clockwise, the chambers 61 and 61a form the high-pressure chambers, whereas the chambers 62 and 62a are then low-pressure chambers.

In order to realize a pressure equalization between the two high-pressure chambers 61 and 61a, corresponding connecting channels 63 are provided between the chambers 61 and 61a and 62 and 62a.

Between the radially outer end of the separating units 5 and the inner circumference of the damper volume 60, which, in principle, is of cylindrical shape, there is formed a radial gap 27, which serves here as damping channel 17. Furthermore, radial gaps 26 are formed between the radially inner end of the separating units 4 and the damper shaft 3. Here, the gaps 26 are dimensioned such that proper rotatability of the damper shaft 3 is made possible and such that jamming of the magnetorheological particles in the magnetorheological fluid within the damper volume 60 at the gaps 26 is reliably avoided. For this purpose, the gap 26 must have at least a gap height greater than the largest diameter of the particles in the magnetorheological fluid.

A gap 26 of such a size, of the order of approximately 10 μm to 30 μm, would normally have the effect that a considerable leakage flow flows through the gap 26. This would be effective in preventing a high pressure build-up in the chambers 61 and 62. This is prevented according to the invention in that the gap 26 is likewise subjected to a magnetic field, such that a magnetorheological seal of the gap 26 is also realized, at least when it is the intention for a braking moment to be applied. In this way, a reliable seal is realized, such that a pressure loss can be substantially avoided.

In FIG. 6, too, recesses 21b are shown which cause a reduction of the base moment. A recess 21b can interact, in particular angle ranges, with a projection 12d.

FIG. 6 shows another exemplary embodiment of a rotary damper 1 according to the invention. The rotary damper 1 has a damper shaft 3, which is mounted rotatably in a housing 12. The damper shaft 3 and the housing are connected to connectors 11 and 13, which are pivotable relative to one another.

The damper volume 60 is again divided by means of separating units 4 and 5 into chambers 61 and 62, as is the case in the exemplary embodiment as per FIG. 5.

Here, too, the housing 12 is composed of 3 housing sections or housing parts, wherein in each case one electrical coil 9 for generating the required magnetic field is accommodated in the axially outer housing parts.

Via an electrical connector 16, the rotary damper 1 is supplied with electrical energy. A sensor device 40 serves for detecting the angular position. It is furthermore possible for a measure for a temperature of the magnetorheological fluid to be detected by means of the sensor device. The signals are transmitted via the sensor line 48.

The separating unit 4 is accommodated in a positionally fixed manner in the housing 12 and is preferably inserted into the housing, and fixedly connected thereto, during the assembly process. In order to prevent a magnetic short-circuit in the regions of the separating unit 4, an insulator 14 is preferably provided between the separating unit 4 and the housing parts 22 and 24 respectively.

FIG. 6 shows the compensating device 30, which comprises an air chamber 32 which is closed off to the outside by means of a cover 35. Toward the inside, the air chamber 32 is adjoined by the separating piston 34, which separates the air chamber 32 from the compensating volume 29. The compensating volume 29 is filled with magnetorheological fluid and provides compensation in the case of temperature fluctuations. Furthermore, the compensating volume 29 serves as a reservoir for leakage losses that arise during ongoing operation.

In the exemplary embodiment as per FIG. 6, in that part of the housing which is not illustrated in section, there is provided a local bypass 21a which reduces the base moment in a basic position 80.

FIG. 7 shows a cross section through the rotary damper as per FIG. 6, wherein it can be seen here that in each case 2 mutually opposite separating units 4 and 5 are arranged in the housing, and fastened to the damper shaft 3, respectively. Chambers 61 and 61a, and 62 and 62a, are formed in the damper volume 60 between the individual separating units 4 and 5. By virtue of in each case two separating units 4 and 5 being used, the acting torque can be doubled. The compensating volume 29 is connected via a channel 36.

The channel 36 is led at the edge of the separating unit 4 into the damper volume 60, in order that a connection to the compensating volume 29 is available even in the case of a maximum pivoting movement between the damper shaft 3 and the housing 12. In this refinement, the compensating volume must be preloaded under the maximum operating pressure by virtue of the air chamber 32 being subjected to a corresponding pressure. The preload may also be imparted by means of a mechanical element such as a spiral spring.

The bypass 21a can be seen in FIG. 7. Furthermore, on the second separating unit 5, a recess 21b can be seen, which may both be provided together.

FIG. 8 shows a cross section through a further exemplary embodiment of a rotary damper 1 according to the invention, which in turn has in each case two separating units 4 and 5, which are in each case connected to the housing and to the damper shaft 3 respectively. Recesses 21b are formed on the separating units 5. In this case, too, two electrical coils are provided, though these are not visible in the illustration as per FIG. 8 because they are arranged on the one hand in front of and on the other hand behind the section plane.

Radially at the outside, between the inner housing wall and the radially outer end of the separating elements 5, there is formed a gap 27 which is subjected to a corresponding magnetic field for the purposes of damping. The gap height 21d in the region of the recesses 21b is considerably greater than a gap height of the gap section 27 axially outside the recesses. Radially at the inside, between the inner end of the separating elements 4 and the damper shaft 3, there is formed in each case one gap 26 which is sealed off by means of a magnetic field.

By contrast to the preceding exemplary embodiment, the compensating volume is in this case connected centrally. The compensating volume 29 is connected via the channel 36 to the interior of a separating unit 4.

FIG. 9 shows the cross section B-B from FIG. 8, and FIG. 10 shows an enlarged detail from FIG. 10. The channel 36 is shown schematically in FIG. 10 and is connected to a channel in which there is arranged a valve unit 31, which in this case is formed as a double valve unit. The valve unit 31 comprises two valve heads 31a at the opposite ends of the channel. Seals 33 serve for sealing when the respective valve head 31 is arranged in its valve seat. The channel 36 opens out in an intermediate region.

On the side on which the higher pressure prevails, the valve head 31 of the valve unit 31 is pushed into the corresponding valve seat. On the other side, the valve head 31a thus lifts off from the valve seat and allows a free flow connection to the channel 36 and thus to the compensating volume 29. In this way, temperature fluctuations can be compensated. Furthermore, in the event of the occurrence of leakage losses, magnetorheological fluid is transferred from the compensating volume into the damper volume.

An advantage of this construction is that the compensating volume only needs to be preloaded under a relatively low preload pressure of 2, 3 or 4 or 5 bar, because the compensating volume is always connected to the low-pressure side and not to the high-pressure side of the rotary damper. Such a refinement reduces the load on the seals and increases the long-term stability. If the compensating volume is connected to the high-pressure side, a preload pressure of 100 or more bar may be expedient.

FIGS. 11 and 12 show cross sections through the rotary damper 1, wherein different cross sections are illustrated. FIG. 11 shows a cross section in which the separating units 4 connected to the housing are illustrated in section. The magnetic insulator between the housing side parts 22 and 24 and the separating wall 4 results in the plotted profile of the magnetic field line. Here, the magnetic field lines pass through the radially inner gap 26 between the inner end of the separating units 4 and the damper shaft 3, and thus reliably seal off the gap there. If the magnetic field is deactivated, the damping is also reduced, and the result is a low base friction.

In the section as per FIG. 11, it is also possible to see the plain bearings 44 for the mounting of the pivot shaft and the seals 28 for sealing off the interior space.

FIG. 12 shows a cross section through the rotary damper 1, wherein, here, the section runs through the damper shaft 3 and a separating unit 5 connected thereto. Here, it is possible to see a recess 21b at the radially outer end of the separating unit 5, which recess provides a bypass in the presence of a weak magnetic field or even in the absence of a magnetic field, and which recess is “closed” in the presence of a strong magnetic field. In addition or instead, a bypass 21a may also be formed over a predefined angle range at an axial gap 25 or in the axial wall 12c of the housing 12, such that a rotational-angle-dependent base moment is provided.

The other, oppositely situated separating unit 5 which is connected to the damper shaft 3 is not illustrated in section here. The profile of a magnetic field line is also plotted by way of example in FIG. 12. It is clear here that the axial gaps 25 between the separating unit 5 and the housing parts 22 and 24 are sealed off by means of the magnetic field. Furthermore, the radial gap 27 between a radially outer end of the separating unit 5 and the housing is also subjected to the magnetic field such that the magnetorheological particles there interlink and seal off the gap.

FIG. 13 shows once again a schematic cross section, which is not true to scale, through a damper device 1, wherein, here, a section through the damper shaft 3 and the separating unit 5 connected thereto is illustrated in the upper half, whereas a section through the separating unit 4 connected to the housing is shown in the lower half. Magnetic field lines are plotted in each case by way of example. Between the separating unit 4 and the damper shaft, there is a thin gap 26 which preferably has a gap height between approximately 10 and 50 μm. In an axial direction, the separating unit 4 lies sealingly against the lateral housing parts. There is a radial gap 27 between the separating unit 5 and the housing 12, and there is in each case one axial gap 25 at the two axial end sides.

In general, the axial gaps 25 are provided with a much smaller gap height than the radial gap 27. The gap width of the axial gaps 25 is preferably similar to the gap width of the radial gaps 26, and is preferably between approximately 10 and 30 μm. The radial gap width 27 is preferably considerably greater, and lies preferably between approximately 200 μm and 2 mm and particularly preferably between approximately 500 μm and 1 mm.

The recess 21b has a width 21e and a radial gap height 21d. The width 21e is preferably less than half and in particular less than ⅓ of an axial width of the separating unit 5, and preferably more than 1/20 and in particular more than 1/10 of an axial width of the separating unit 5.

During the pivoting of the damper shaft 3, the volume of a chamber is reduced in size, and that of the other chamber is increased in size. Here, the magnetorheological fluid must pass over from one into the other chamber substantially through the gap 27. The gap 27 serves here as damping channel 17. As can be clearly seen in FIG. 13, the damping channel 17 is passed through by the magnetic field lines, such that a variable flow resistance can be generated there.

The axial gaps 25 are also sealed off by means of the magnetic field, at any rate if the magnetic field thereof is selected to be of such a strength that it is conducted no longer only through the damper shaft 3. Specifically, it has been found that, with a magnetic field of increasing strength, the entire magnetic field is conducted no longer through the damper shaft 3 but also passes axially through the axial gap 25 and thus, with increasing strength, seals off the entire axial gap 25. Corresponding sealing is realized with a corresponding field strength.

As already described above, the in this case magnetically non-conductive rings 20 serve in this case for preventing a magnetic short-circuit at the electrical coil 9.

FIG. 14 shows various views of the damper shafts 3 equipped with two separating units, wherein the separating units 5 and 5a are situated diagonally oppositely, resulting in a symmetrical construction.

At the top right in FIG. 1, a schematic cross section through an embodiment in which a bypass 21a is formed for example in the manner of a groove into the inner wall of the housing 12 is shown. The groove has a groove depth which varies over the circumference. Toward the lateral region, the radial depth of the groove or of the bypass 21a may decrease to zero. Then, an intense decrease of the base moment is attained in the middle region. With progressive pivoting, the base moment increases.

At the bottom left in FIG. 14, in the left-hand half, an insert 50 has been inserted at a recess, which insert provides two or more passage gaps 21c. At the right-hand half, in the separating unit 5 shown there, a recess 21b is shown which, in the illustrated angle position, is filled or closed off to a considerable extent by a projection 12d in order to influence the (effective) flow cross section for the base moment in targeted fashion.

At the bottom right in FIG. 14, an enlarged detail with a cross section of a separating unit 5 and with a channel or bypass 21a on the inner wall 12b of the housing 12 is schematically shown. It can be seen that there is a considerably greater gap height in the angle range 38 of the channel or bypass 21a than in the axially adjacent regions with the radial gap 27. Here, relative constrictions at the circumferential ends of the channel or bypass 21a can also be seen. It is also possible for the channel or bypass 21a to extend over a somewhat greater angle range, such that a relatively large gap height is realized over the full width of the separating unit. The configuration shown is however advantageous because, in the region of the constrictions, the magnetic field can more easily seal off the gap in a reliable manner.

In FIG. 14, it is possible to see the two connecting channels 63 which connect in each case 2 oppositely situated chambers 61 and 61a, and 62 and 62a, to one another. In order to allow a pressure equalization between the two high-pressure chambers and the two low-pressure chambers, whereas an exchange of pressure or an exchange of fluid from a high-pressure chamber and a low-pressure chamber is possible only via the damping channel 17.

FIG. 15 shows a cross section through a further rotary damper 1. This rotary damper is of particularly small construction. The rotary damper 1 from FIG. 15 can be used in all exemplary embodiments and is basically identical in terms of construction. In the section, it is possible to see the separating units 4 connected to the housing. The magnetic insulator 14 between the housing side parts 22 and 24 and the separating wall 4 results in a profile of the magnetic field lines similar to FIG. 11. If the magnetic field is deactivated, it is also the case here that the damping is reduced and a low base friction results. The ring 20 is in this case of magnetically conductive form in order to ensure a reliable seal of the lateral axial gaps 26 in the region of the separating element 5. The seal is reliably attained if a sufficient magnetic field strength is present. Here, too, as in FIG. 11, the plain bearings 44 for the mounting of the pivot shaft and the seals 28 for sealing off the interior space can be seen.

The electrical coils 9 are arranged radially in the region of the damper volume. In the region of the pivot vanes, a reliable seal even of the lateral axial gaps 26 is attained by means of the frustum form, provided with a hollow cylinder, of the rings 20. The rings 20, which are composed here of magnetically conductive material, ensure a reliable seal of the axial sealing gaps 26 in the region of the pivot vanes or separating elements 5.

FIG. 16 shows a variant similar to FIG. 7, wherein, here, it is again the case that in each case two separating units are fastened to the housing and to the damper shaft 3. As is also the case in FIG. 15, a recess 21b is shown on one separating unit 5 in FIG. 16. The in each case symmetrically arranged separating units 4 and 5 thus allow a pivoting movement of the damper shaft 3 through almost 180°. Between the individual separating units 4 and 5, there are formed in each case two high-pressure chambers and two low-pressure chambers. Here, the separating units 4 and 5 are of rounded and streamlined form in order that no flow separation occurs, and thus undesired deposits from the magnetorheological fluid are avoided. A compensating device 30 with a compensating volume 29 is also provided. Finally, FIG. 17 shows a yet further exemplary embodiment, wherein, here, the rotary damper 1 is additionally equipped with a spring in the form of a torsion bar. The damper shaft is coupled to one side, and the housing is coupled to the other side, such that a relative movement or relative rotation of the components with respect to one another can be dampened in controlled fashion by means of the rotary damper 1. The components may be settable and also completely decouplable. In this way, an active apparatus is provided which can be set for different conditions.

In FIG. 17, it is furthermore the case that the damper shaft 3 is of hollow design. The spring, for example in the form of a torsion bar, is arranged in the interior of the damper shaft, such that a resetting action is possible by means of the spring force of the spring 47.

FIG. 18 shows a further rotary damper 1 in a partial section, wherein the rotary damper 1 basically functions in the same way as, for example, the rotary damper as per FIG. 3. Therefore, the same reference designations are also used where possible, and the above description also applies identically to the rotary damper 1 of FIGS. 18-20, unless a contrary or supplementary description is given or corresponding information emerges from the drawings. Local bypasses 21a and/or recesses 21b and/or passage gaps 21c are provided. FIG. 21 shows a variant of the rotary damper 1 as per FIG. 18.

The rotary damper 1 from FIG. 18 likewise has a housing 12 and a damper shaft 3, which are designed to be pivotable relative to one another. The damper shaft 3 is mounted rotatably in the housing 12 by means of rolling bearings 44. The damper shaft 3 is formed here from a total of three parts, as will be discussed with reference to FIG. 20.

The housing 12 comprises a first end part 22 and a second end part 24 at the other end, and a middle part 23 arranged in between. At both ends, there are also accommodated outer housing parts 12a, on which screw openings are formed. On the radially outer housing part 12a, a non-circular coupling contour 70 with recesses is formed in the region of the end of the reference designation line. Multiple recesses arranged so as to be distributed over the circumference form the non-circular coupling contour, whereby a rotationally conjoint connection to further components is possible.

In the two end parts 22 and 24, there is accommodated in each case one encircling electrical coil 9 which serves for generating the magnetic field required for the damping.

In all exemplary embodiments, the magnetic field is controllable. As in all exemplary embodiments and refinements, more intense damping (braking action) is generated in the presence of a relatively strong magnetic field. At the same time, by means of the relatively strong magnetic field, a better seal of the gaps 25, 26 and 27 (compare the schematic illustration as per FIG. 13) is attained. Conversely, in all exemplary embodiments and refinements, relatively weak damping (braking action) is set by means of a relatively weak magnetic field. At the same time, in the presence of a relatively weak magnetic field, the sealing action at the gaps 25 to 27 is also reduced. This results in a lower base moment which acts in the absence of a magnetic field. The sealing action of the gaps 25 to 27 is low in the absence of a magnetic field. In this way, a broad setting range can be provided, which is not possible in the prior art. The ratio of maximum torque (or maximum braking action) to minimum torque (or minimum braking action) is very large, and greater than in the prior art, within the provided pivot angle or within the working range. The base moment can be reduced in certain angle ranges by mechanical means and through targeted control of the magnetic field.

By contrast, in the case of conventional rotary dampers, the minimum torque is already large if a high maximum torque is to be generated. This is because the seals of the gaps must be designed such that a reliable or adequate seal is ensured even in the presence of high acting pressures. Conversely, in the case of rotary dampers which are intended to have a low braking moment in operation without load, only a low maximum torque is attained, because the seals are designed such that only little friction is generated. In the presence of high acting pressures, this results in a considerable leakage flow, which greatly limits the maximum possible torque.

The interior space of the rotary damper 1 provides a damper volume. In the housing, there is formed a displacement device 2 which comprises separating units 4 and 5. The separating units 4 and 5 divide the damper volume 60 into two or more chambers 61 and 62. Here, the separating unit 4 is formed as a separating wall and is fixedly connected to the housing 12. The separating unit 5 is likewise formed as a separating wall or as a pivot vane and is fixedly connected to the damper shaft 3. Preferably, the separating unit 5 is formed in one piece with the damper shaft 3. Here, the damper volume 60 is filled with magnetorheological fluid 6. A seal of the damper volume 60 to the outside is realized by means of a seal 28 in the housing part 22. During a pivoting movement, the separating units 4 and 5 displace the magnetorheological fluid (MRF) contained in the damper volume, such that the MRF flows over partially from one chamber into the other. A connecting channel or compensating channel 63 serves for pressure equalization between the chambers 61 and 61a. A corresponding second connecting channel 63a (cf. FIG. 20) serves for pressure equalization between the chambers 62 and 62a.

At the rear end, it is also possible in FIG. 18 to see a valve 66, by means of which a compressible fluid is introduced into the compensating device 30. In particular, nitrogen is used. The valve 66 may for example be integrated into a screwed-in enclosure or cover.

At the front end, it is possible in FIG. 18 to see, outside the housing 12 of the rotary damper 1, a mechanical stop 64 which mechanically limits the possible pivoting range in order to protect the pivot vanes in the interior against damage.

The magnetic field source 8 in the housing part 22 is composed here of electrical coils 9, which are each of ring-shaped form and accommodated in the housing part 22. Here, in the exemplary embodiment, electrical coils 9 are provided in both end parts. The magnetic field strength can be predefined by means of a controller.

Here, two separating units 4 project radially inward into the damper volume 60 from the housing. The separating units 4 form separating walls and thus limit the possible rotational movement of the damper shaft 3, on which there are likewise formed two separating units 5 which project radially outward from the damper shaft. Rotation of the damper shaft 3 causes the separating walls 5, which in this case form pivot vanes, to be pivoted. The chambers 61 and 61a are correspondingly reduced in size (cf. FIG. 19) or increased in size again.

In FIG. 19, it is also possible to see four bleed valves which were used in a prototype in order to achieve faster filling and emptying and which possibly need not (all) be implemented.

As is also shown in FIG. 20, the electrical coils 9 are in this case, in the exemplary embodiment, arranged radially relatively far radially to the outside and are delimited in an axially inward direction in each case by a magnetically non-conductive or only poorly conductive ring 20, which serves for shaping the magnetic field profile. The ring 20 has in particular a hollow cylindrical shape.

In the complete longitudinal section as per FIG. 20, it is possible to see the compensating device 30, which in this case is accommodated in the interior of the damper shaft 3. The compensating device 30 comprises a compensating volume 29 which is filled with MRF and which is separated from the air chamber 32 by means of a movably arranged separating piston 34. Both the air chamber 32 and the separating piston 34 and the compensating volume 29 are accommodated, within a hollow cylindrical receiving space 30a, entirely in the interior of the damper shaft 3. The hollow cylinder 30a is closed off at the axially outer end by means of a closure with the valve 66. This refinement allows a particularly compact and space-saving design, in the case of which only very few parts project from the rotary damper 1, which is basically of substantially cylindrical form. This increases the installation and usage possibilities.

The compensating device 30 is, in FIGS. 18 to 20, connected via channels (not illustrated) to the channel 72, which in this case is closed by means of a closure 71. In this way, it is optionally possible for an external compensating device 30 to be coupled on and for an insert to be inserted in the interior in order to substantially fill the volume of the hollow cylinder 30a. In this way, it is for example possible for a particularly large temperature range to be compensated. It is also possible in this way to ensure a particularly long service life, even if a certain amount of leakage occurs.

In FIG. 20, it is possible to clearly see the in this case three-part damper shaft 3, which is composed here of the hollow shaft 3a, the attachment shaft 3b and the projection 3c. The three parts are coupled rotationally conjointly to one another. It is also possible for the damper shaft 3 to be of two-part or else only single-part form.

FIG. 21 shows a variant of the exemplary embodiment as per FIGS. 18 to 20, wherein, here, an external compensating device 30 has been coupled on. The further components may be identical. In practical terms, on the rotary damper 1 as per FIG. 18, the closure 71 can be removed, and the illustrated external compensating device can be screwed on. In the interior, there is formed an air or fluid chamber 32, which is separated from the compensating volume 29, which is filled with MRF, by means of a separating piston 34.

In the interior, an insert 67 is accommodated in the hollow cylinder 30a in order to fill the volume.

In the exemplary embodiment as per FIG. 21, two angle sensors 68 and 69 are also attached. Here, one angle sensor 68 measures the absolute angle position with relatively low accuracy, and the angle sensor 69 measures a relative angle position with relatively high accuracy. In this way, a highly accurate sensor system can be provided which operates robustly and reliably and nevertheless with high accuracy.

Altogether, an advantageous rotary damper 1 is provided. In order to be able to compensate the temperature-induced volume expansion of the MR fluid (MRF) and of the adjacent components, it is expedient for an adequate compensating volume to be provided.

In one specific case, approximately 50 ml MRF is required per individual actuator or rotary damper, and thus 150 ml is required for the overall system. As a preload element, use is preferably made of a nitrogen volume, which is preloaded in particular with approximately 75 bar.

In this example, a coil wire with an effective cross section of 0.315 mm² was used. The number of windings of 400 yielded a fill factor of approximately 65% with a resistance of 16 ohms. With a larger wire diameter, an even higher coil speed can be achieved.

An axial play of the separating walls or pivot vanes is preferably set. For proper functioning of the actuator, it is advantageous for the axial position of the pivot vane 5 relative to the housing to be centered and set. For this purpose, use may for example be made of threaded setting rings which are brought into the central position by means of a dial gauge.

In one specific case, filling with MRF was performed, wherein (almost) 75 ml of MRF was introduced. For the introduction, the MRF may be introduced via the compensating volume. By moving the pivot vane in alternating fashion, the MRF can be distributed within the chambers 61, 62 (pressure chamber), and air inclusions can be conveyed upward. Subsequently, the system can be preloaded with nitrogen (approximately 5 bar). Thereafter, the bleed screws 65 on the outer side of the housing 12 can be opened in order to allow the enclosed air to escape. The nitrogen chamber 32 was subsequently preloaded to 30 bar for initial tests on the test stand.

As an optimization measure, the actuator can also be placed into a negative-pressure environment in order to be able to better evacuate possible air inclusions.

High pressures are attained without a mechanical seal. The rotary damper 1 is inexpensive to produce and is robust and durable.

In this specific example, a braking moment of >210 Nm was attained on the test stand. The unit is of smaller, more lightweight and less expensive construction than in the prior art.

Switching times of <30 ms are possible and were able to be demonstrated (full-load step change).

The braking moment can be varied as desired. No mechanical moving parts are required for this purpose. The control is performed easily merely by variation of electrical current or magnetic field.

A considerable advantage is attained owing to an absence of mechanical seals. In this way, a very low base moment of less than 0.5 Nm is attained. This is attained in that not only the braking moment but simultaneously also the sealing action of the seals is controlled. Altogether, the result is a very low power requirement of for example a few watts.

The rotary damper 1 can be used in various technical devices. One application is for example also in vehicles and in particular motor vehicles in, for example, stabilizers, steer-by-wire systems or on brake, accelerator or clutch pedals. A corresponding rotary damper 1 can be installed in these systems. Here, the dimensioning can be adapted to the desired forces and moments to be imparted.

### LIST OF REFERENCE DESIGNATIONS

1 Rotary damper
2 Displacement device
3 Damper shaft
3a Hollow shaft
3b Attachment shaft
4 Separating unit, separating wall
5 Separating unit, separating wall
6 MRF
7 Control device
8 Magnetic field source
9 Electrical coil
10 Magnetic field
11 Connector (on 12)
12 Housing of 2
12a Outer housing part
12b Wall, inner wall
12c Axial wall
12d Projection, lug
13 Connector (on 3)
14 Insulator
15 Hydraulic line
16 Electrical connector
17 Damping channel
19 Axis of 3, 9
20 Ring in 12
21 Flow cross section
21a Bypass
21b Recess in 5
21c Passage gap
21d Gap height
21e Gap width
21f Web
22 First end region
23 Central region
24 Second end region
25 Gap, axial gap
26 Gap, radial gap
27 Gap, radial gap
28 Seal on 3
29 Compensation volume
30 Compensation device
30a Hollow cylinder
31 Valve unit
31a Valve head
32 Air chamber
33 Seal
34 Separating piston
35 Cover
36 Channel
37 Energy store
38 Angle range
39 Permanent magnet
40 Sensor device
41 Spacing
42 Seal of 23
43 Intermediate space
44 Bearing
45 Load sensor
46 Arm
47 Spring, torsion bar
48 Sensor line
49 Holder, spacer
50 Insert
51 One-way valve
52 Valve unit
53 Movement direction
54 Pressure accumulator
55 Arrow direction
56 Permanent magnet
60 Damper volume
61, 62 Chamber
63 Connecting channel
63a Second connecting channel
64 Mechanical stop
65 Bleed screw
66 Nitrogen valve
67 Insert
68, 69 Sensor
70 Non-circular coupling contour
71 Closure
72 Channel
80 Basic position
100 Apparatus, stabilizer
101 Door
102 Stabilizer rod
103 Stabilizer rod
111 Distal end
112 Distal end
300 Training appliance
301 Actuating element
302 Control device
305 Seat
309 Lever

1-27. (canceled)

28. A rotary damper, comprising:
a housing, a damper shaft rotatably mounted relative to said housing, magnetorheological fluid accommodated in a damper volume in said housing, and a magnetic field source for influencing a damping of a rotational movement of said damper shaft relative to said housing
at least one separating unit connected to said damper shaft and dividing said damper volume, said at least one separating unit and said housing forming at least one gap section therebetween to be exposed to a magnetic field of said at least one magnetic field source;
said housing, said separating unit, and said magnetic field source being formed such that a flow cross section for the magnetorheological fluid from one side of said separating unit to an opposite side of said separating unit changes in dependence on an angle of rotation.

29. The rotary damper according to claim 28, wherein said housing is formed with a wall surrounding said damper volume and said wall is formed with a bypass that extends over a limited angle range and/or acts over a limited angle range.

30. The rotary damper according to claim 29, wherein a cross section of said bypass is angle-dependent.

31. The rotary damper according to claim 28, wherein at least one recess is formed in said separating unit.

32. The rotary damper according to claim 31, wherein a cross section of said recess changes in an angle-dependent manner due to a projection.

33. The rotary damper according to claim 31, wherein said recess adjoins a gap section.

34. The rotary damper according to claim 28, wherein the flow cross section is larger in a basic position than in a rotational position that differs substantially from said basic position.

35. The rotary damper according to claim 31, wherein said recess is a passage gap in a separating wall of said separating unit.

36. The rotary damper according to claim 35, wherein a cross section of said passage gap extends farther in an axial direction than in a radial direction.

37. The rotary damper according to claim 35, wherein two or more passage gaps are formed on the separating wall and said passage gaps are separated from one another by a magnetically conductive web.

38. The rotary damper according to claim 35, wherein at least one passage gap is formed on an insert which is accommodated on the separating unit.

39. The rotary damper according to claim 28, wherein said separating wall, axially adjacent to a passage gap, is composed of a material which exhibits poorer magnetic conductivity than a radially adjacent section of said separating wall.

40. The rotary damper according to claim 28, wherein said separating wall, close to or at an axial edge, is composed of a magnetically conductive material or comprises a permanent magnet.

41. The rotary damper according to claim 28, further comprising a one-way valve disposed in a channel section or bypass.

42. The rotary damper according to claim 28, which comprises a displacement device with at least two separating units dividing the damper volume into at least two variable chambers; and
wherein at least one of said separating units comprises a separating wall connected to said housing; and
at least one of said separating units comprises said separating wall connected to said damper shaft.

43. The rotary damper according to claim 28, wherein:
said at least one gap section is one of a plurality of gap sections;
one of said gap sections is formed in a radial direction between said damper shaft and a separating unit that is connected to said housing;
another one of said gap sections is formed in a radial direction between said separating unit that is connected to said damper shaft and said housing; and
at least one further gap section is formed in an axial direction between said separating unit that is connected to said damper shaft and said housing.

44. The rotary damper according to claim 44, wherein said magnetic field source comprises at least one controllable electrical coil configured to influence a strength of the magnetic field and an intensity of a damping action, and wherein at least a major part of the magnetic field of said magnetic field source passes through at least two of said gap sections and influences said at least two gap sections simultaneously in dependence on the strength of the magnetic field.

45. The rotary damper according to claim 44, wherein said separating unit that is connected to said damper shaft has two axial ends and, at each of said axial ends an axial gap section formed between said housing and a separating wall of said separating unit, and wherein a major part of the magnetic field of the magnetic field source passes through both axial gap sections between said housing and said separating wall and effects a seal of said axial gap sections.

46. The rotary damper according to claim 28, wherein said housing comprises a first end part, a second end part, and a middle part between said first and second end parts, wherein said magnetic field source includes an electrical coil accommodated in at least one of said first and second end parts, and wherein an axis of said electrical coil is oriented substantially parallel to said damper shaft.

47. The rotary damper according to claim 28, further comprising a ring arranged axially adjacent to an electrical coil in said housing, and wherein said ring is arranged axially between said electrical coil and said damper volume.
